(19) United States
(12) Patent Application Publication
(10) Pub. No.: US 2021/0284832 A1
(43) Pub. Date: Sep. 16, 2021

(54) COMPOSITIONS AND METHODS FOR MAKING FIRE-RESISTANT EPDM RUBBER

(71) Applicant: CARLISLE CONSTRUCTION MATERIALS, LLC, Carlisle, PA (US)

(72) Inventor: Onno FOKKINGA, Kampen (NL)

(73) Assignee: CARLISLE CONSTRUCTION MATERIALS, LLC, Carlisle, PA (US)

(21) Appl. No.: 17/198,840

(22) Filed: Mar. 11, 2021

Related U.S. Application Data
(60) Provisional application No. 62/988,558, filed on Mar. 12, 2020.

(51) Int. Cl. C08L 23/16; C08K 3/04; C08K 3/22; C08K 3/06; C08K 5/09; C08K 5/44; C08K 5/521; C08K 5/40; C08F 36/06; C08F 22/06; B32B 27/12; B32B 27/32; B29C 48/35

(52) U.S. Cl. CPC C08L 23/16; B32B 2419/06; C08K 3/22; C08K 3/06; C08K 5/09; C08K 5/44; C08K 5/521; C08K 5/40; C08F 36/06; C08F 22/06; B32B 27/12; B32B 27/32; B29C 48/35; C08K 2003/2227; C08K 2003/2296; C08K 2201/019; C08L 2201/02; B32B 2250/02; B32B 2250/03; B32B 2250/40; B32B 2260/021; B32B 2315/08; C08K 3/04

(57) ABSTRACT

The disclosure herein relates to ethylene propylene diene monomer (EPDM) rubber. More specifically, the present disclosure relates to fire-resistant EPDM rubber. In one embodiment, the fire-resistant EPDM is a membrane used for weatherproofing buildings. In another embodiment, the fire-resistant EPDM membrane is a roofing material. In other embodiments, the fire-resistant EPDM rubber can be used in the electrical field.

### CROSS-REFERENCE TO RELATED APPLICATION

The present application claims priority to U.S. Provisional Patent Application Ser. No. 62/988,558, of same title, filed Mar. 12, 2020; the entire disclosure of which is incorporated herein by reference in its entirety for all purposes.

### TECHNICAL FIELD

The disclosure herein relates to ethylene propylene diene monomer (EPDM) rubber. More specifically, the present disclosure relates to fire-resistant EPDM rubber. In one embodiment, the fire-resistant EPDM rubber is used for weatherproofing buildings, in particular as a membrane for façade application.

### BACKGROUND

Ethylene propylene diene monomer (EPDM) rubber has many remarkable properties such as heat resistance, chemical resistance, low electrical conductivity, stability at temperatures ranging from −50° F. to 350° F., flexibility at low temperatures, and weather resistance, to name a few. EPDM is cost effective and can be fabricated in a variety of ways including custom molding and extruding. EPDM has numerous applications in the automotive industry (e.g., hoses, seals, O-rings, gaskets, accumulator bladders, wire and cable connectors and insulators, diaphragms, and weather stripping); construction (e.g., roofing and waterproofing); HVAC (e.g., compressor grommets, tubing, gaskets, and seals); and many other industries.

The main drawback to EPDM rubber is its flammability. In the construction industry, fire resistance is generally achieved through two different methods, the first is the addition of an external retardant and the second is the use of a ballasted roof system. Accordingly, there is a need for a fire-resistant EPDM rubber.

### SUMMARY

The disclosure herein is directed to fire-resistant EPDM rubber. In one embodiment, the EPDM includes ethylene propylene diene monomer (EPDM) polymer, aluminum hydroxide, tris(2-ethylhexyl) phosphate, expendable graphite, and a maleic anhydride adduct of polybutadiene; wherein the composition does not contain mineral oil. The foregoing composition can also include a curing agent such as sulfur or a sulfur releasing compound. The foregoing composition can also include activators and/or accelerators such as zinc oxide, steric acid, tetrabenzyl thiuram disulfide. In one embodiment, the composition is halogen free. In one embodiment, the composition is antimony trioxide free. In one embodiment, the composition is halogen free and antimony trioxide free.

A non-limiting example of a fire-resistant EPDM formulation is sulfur, tetrabenzyl thiuram disulfide, N-cyclohexyl-2-benzothiazylesulphenamide, zinc oxide, stearic acid, a maleic anhydride adduct of polybutadiene, expandable graphite, carbon black N550, tris(2-ethylhexyl) phosphate, and aluminum hydroxide. In one embodiment, the composition does not include mineral oil. In one embodiment, the composition may be halogen free. In one embodiment, the composition may be antimony trioxide free. In one embodiment, the composition may be both halogen free and antimony trioxide free.

In another aspect of the invention there is provided a method for making an EPDM roofing membrane comprising the steps of: processing a homogeneous mixture of the composition of any one of the previous embodiments using either calendaring or a roller die extruder; and heat curing the membrane with or without pressure.

### DETAILED DESCRIPTION

Ethylene propylene diene monomer (EPDM) rubber is a synthetic rubber compound made from ethylene, propylene, and diene monomers that can be crosslinked via sulfur vulcanization. Because EPDM is purely a hydrocarbon, it can easily catch fire. This disclosure is directed to an EPDM rubber that is fire-resistant. In particular, this disclosure is directed to an EPDM rubber that meets the European Classification for building materials EN 13501-1 class B.

### Definitions

In the description that follows, a number of terms are extensively utilized. The following non-limiting definitions provide a clear and consistent understanding of the specification and claims, including the exemplary scope to be given such terms.

When the terms “one,” “a,” or “an” are used in this disclosure, they mean “at least one” or “one or more,” unless otherwise indicated.

The terms “invention” or “present invention” as used herein are intended to be non-limiting and are not intended to refer to any single embodiment of the particular invention but encompasses all possible embodiments as described in the specification and the claims and their equivalents.

When proportions of constituent ingredients are expressed in percentages, they should be understood to be expressed as parts per hundred rubber (PHR).

### Composition

EPDM rubber compounds generally include an EPDM polymer, (providing waterproof and elastic properties) and one or more of the following: (1) oil extenders; (2) crosslinkers/curing agents; (3) processing aids; (4) accelerators (which assist the vulcanization process); (5) antioxidants (for weather resistance); (6) antiozonants (for ozone resistance); (7) softeners and plasticizers (which improve pliability); (8) fillers, reinforcing (which increase moduli of elasticity and toughness) and/or non-reinforcing; (9) flame retardants; and (10) other agents.

Various diene monomers can be used in the formation of the EPDM polymer. Non-limiting examples of suitable diene monomers include ethylidene norbornene, dicyclopentadiene, vinyl norbornene, alkyldicyclopentadiene, 1,4-pentadiene, 1,4-hexadiene, 1,5-hexadiene, 1,4-heptadiene, 2-methyl-1,5-hexadiene, cyclooctadiene, 1,4-octadiene, 1,7-octadiene, 5-ethylidene-2-norbornene, 5-n-propylidene-2-norbornene, and 5-(2-methyl-2-butenyl)-2-norbornene, and mixtures thereof.

In certain embodiments, the oils may be halogenated.

Non-limiting examples of suitable crosslinkers/curing agents include peroxides such as alpha-cumyl hydroperoxide, methylethylketone peroxide, hydrogen peroxide, acetylacetone peroxide, t-butyl hydroperoxide, t-butyl peroxybenzoate, 2,5-bis(t-butylperoxy)-2,5-dimethylhexene, lauryl peroxide, benzoyl peroxide, 2,4-dichlorobenzoyl peroxide, dibenzoyl peroxide, bis(p-monomethylene-benzoyl) peroxide, bis(p-nitrobenzoyl peroxide, phenylacetyl peroxide, p-quinone dioxime, lead peroxide, zinc peroxide, barium peroxide, copper peroxide, potassium peroxide, silver peroxide, sodium peroxide, calcium peroxide, metallic peroxyborates, peroxychromates, peroxydicarbonates, peroxydiphosphates, peroxydisulfates, peroxygermanates, peroxymolybdates, peroxynitrates, magnesium peroxide, sodium pyrophosphate peroxide, and mixtures thereof. Other non-limiting examples of crosslinkers/curing agents include sulfur with accelerators, resins, and radiation.

Non-limiting examples of suitable processing aids include hydrocarbon resins, fatty acid soaps, fatty acid esters, paraffins, polyethylene waxes, EVA waxes, phenolic resins, poly(ethylene-co-acrylic acid), and mixtures thereof.

Non-limiting examples of suitable accelerators include sulfur, mercaptans, benzothiazoles, thiurams, zinc oxide, stearic acid, benzothiazolesulfenamides, dithiocarbamates, thioureas, N-cyclohexyl-2-benzothiazolesulfenamide (CBS), N-tert-butyl-2-benzothiazolesulfenamide (TBBS), 2,2′-dithiobis(benzothiazole) (MBTS), tetramethyl thiuram disulfide (TMTD), tetramethyl thiuram monosulfide (TMTM), zinc dibutyl dithiocarbamate (ZDBC), zinc dimethyl dithiocarbamate (ZDM), tetrabenzyl thiuram disulfide (TBzTD), di-o-tolylguanidine (DOTG), diphenylguanidine (DPG), 4,4′-dithiodimorpholine (DTDM), hexamethylenetetramine (HMTA), mercaptobenzothiazole (MBT), nickel dibutyl dithiocarbamate (NDBDC), N-(cyclohexylthio) phthalimide (PVI), copper dialkyl dithiophosphate (CUT), dithiocaprolactam, zinc amine-dithiophosphate (ZAT), tetrabutyl thiuram disulfide (TBTS), zinc dibenzyl dithiocarbamate (ZBEC), zinc dialkyl dithiophosphate (ZDDP), zinc diethyl dithiocarbamate (ZDEC), zinc ethyl phenyl dithiocarbamate (ZEPD), dipentamethylene thiuram tetrasulfide (DPTT), 2-mercaptobenzothiazoles; 2,2′-dithiobenzothiazole, N-cycohexylbenzothiazole-2-sulfenamide, N-tert-butylbenzothiazole-2-sulfenamide, tetramethyl thiuram disulfide, tetramethyl thiuram monosulfide, tetrabutyl thiuram disulfide, tetraethyl thiuram monosulfide, dipentamethylene thiuram hexasulfide, N,N-dibutyl thiourea, N,N-diethyl thiourea, sulfur donor-type accelerators, other organic accelerators, and mixtures thereof.

Non-limiting examples of suitable softeners and plasticizers include paraffinic oils, naphthenic oil, diisononyl phthalate (DINP), diisodecyl phthalate (DIDP), dioctyl phthalate (DOP), di-n-hexyl phthalate, isodecyl diphenyl phosphate (e.g., Santicizer® 148), tris(2-ethylhexyl) phosphate (TEHP), and mixtures thereof.

Non-limiting examples of suitable fillers include carbon black, clay, talc, ground coal, silicas, mica, calcium carbonate, other organic materials, and mixtures thereof.

Non-limiting examples of suitable flame retardants include aluminum hydroxide (also referred to as aluminum trihydroxide), magnesium hydroxide, expandable graphite, zinc borate, ammonium polyphosphate, melamine polyphosphate, antimony oxide, and mixtures thereof.

Non-limiting examples of other suitable agents include a maleic anhydride adduct of polybutadiene, anti-degradants (e.g., waxes and paraffinic products), poly(1,2-dihydro-2,2,4-trimethylquinoline (TMQ), methyl-2-mercaptobenzimidazole (MMBI), N-isopropyl-N′-phenyl-1,4-phenylenediamine (IPPD), N-(1,3-dimethylbutyl)-N′-phenyl-p-phenylenediamine (6PPD), butylated hydroxytoluene (BHT)), and mixtures thereof.

In certain embodiments, the EPDM rubber compound includes a flame retardant. In such embodiments, the amount of flame retardant can be from about 2% to about 90%. In certain embodiments, the flame retardant is aluminum hydroxide, expandable graphite, or both. In such embodiments, the amount of aluminum hydroxide can be from about 10% to about 90%, and the amount of expandable graphite can be from about 2% to about 25%.

In certain embodiments, the EPDM rubber compound includes a crosslinker. In such embodiments, the amount of cross linker can be from about 1% to about 10%. In certain embodiments, the crosslinker can be a maleic anhydride adduct of polybutadiene. In such embodiments, the amount of maleic anhydride adduct of polybutadiene can be from about 1% to about 10%.

In certain embodiments, the EPDM rubber compound includes a plasticizer. In such embodiments, the amount of plasticizer can be from about 1% to about 60%. In certain embodiments, the plasticizer is not mineral oil. In certain embodiments, the plasticizer is tris(2-ethylhexyl) phosphate. In such embodiments, the amount of tris(2-ethylhexyl) phosphate can be from about 1% to 25%.

In certain embodiments, the EPDM rubber compound includes fillers. In such embodiments, the amount of fillers can be from about 1% to about 50%. In certain embodiments, the filler can be carbon black. In such embodiments, the amount of carbon black can be from about 1% to about 50%.

In certain embodiments, the EPDM rubber compound includes a curing agent. In such embodiments, the amount of curing agent can be from about 1% to about 5%. In certain embodiments, the curing agent is sulfur. In such embodiments, the amount of sulfur can be from about 1% to about 3%.

In certain embodiments, the EPDM rubber compound includes an accelerator. In such embodiments, the amount of accelerator can be from about 1% to about 10%. In certain embodiments, the accelerator is tetrabenzyl thiuram disulfide, zinc oxide, steric acid, or combinations thereof. In such embodiments, the amount of tetrabenzyl thiuram disulfide can be from about 1% to about 8%, the amount of zinc oxide can be from about 1% to about 10%, and the amount of steric acid can be from about 1% to about 5%.

In certain embodiments, the EPDM rubber compound includes EPDM, aluminum hydroxide, expendable graphite, and a maleic anhydride adduct of polybutadiene. In one embodiment, the compound does not contain mineral oil. In one embodiment, the compound is halogen free. In one embodiment, the compound is antimony trioxide free. In one embodiment, the compound is both halogen and antimony trioxide free.

In certain embodiments, the EPDM rubber compound includes EPDM, sulfur, tetrabenzyl thiuram disulfide, N-cyclohexyl-2-benzothiazylesulphenamide, zinc oxide, stearic acid, a maleic anhydride adduct of polybutadiene, Carbofoil L-120, carbon black n550, tris(2-ethylhexyl) phosphate; and aluminum hydroxide. In one embodiment, the compound does not contain mineral oil. In one embodiment, the compound is halogen free. In one embodiment, the compound is antimony trioxide free. In one embodiment, the compound is both halogen and antimony trioxide free.

### Methods

Making the EPDM rubber products generally involves two steps, processing a mixture into a product, and then curing the product. To form a homogenous mixture, the ingredients may be blended together using a high-shear mixing machine such as an internal mixer. Non-limiting examples of suitable mixers include Banbury mixers, which are internal mixers or mills or extruders. During the processing step, the homogenous mixture may be formed into its final shape using molding, calendaring, or extruding (e.g., a roller die). Curing may be done using various methods including heating (with or without pressure) and radiation (with or without pressure).

In one embodiment, the EPDM rubber compounds described herein may be processed into roofing material, specifically an EPDM membrane for façade application. The membranes are generally about 0.5 millimeters (mm) thick to about 3 mm thick. The membranes are generally made of one layer of EPDM rubber or two or more layers of EPDM rubber that may be calendared or laminated together. In some embodiments, the membranes can include a fabric layer in or laminated on one or both sides. In some embodiments, the membranes can include a glass scrim layer adhered to one or both sides.

### EXAMPLES

### Example 1—EPDM Rubber Formula

In this example, various fire-resistant EPDM rubber membranes were made using the following formulas.

| Material | CAS No. | PHR* |
|---|---|---|
| EPDM | 025038-36-2 | 100 |
| Sulfur | 7704-34-9 | 0.9 |
| Tetrabenzyl thiuram disulfide | 10591-85-2 | 0.28 |
| N-cyclohexyl-2-benzothiazylesulphenamide | 000095-33-0 | 0.56 |
| Zinc Oxide | 001314-13-2 | 3 |
| Stearic acid | 57-11-4 | 1 |
| Maleic anhydride adduct of polybutadiene | | 2.94 |
| Expandable graphite | 12777-87-6 | 20 |
| Carbon black N550 | 001333-86-4 | 20 |
| tris (2-ethylhexyl) phosphate | 000078-42-2 | 20 |
| Aluminum Hydroxide | 021645-51-2 | 180 |

*PHR = Parts per Hundred Rubber

The materials in the amounts listed above were added to a Banbury mixer, and mixed for 5 minutes reaching a final temperature of 135° C. The mixture was dropped onto a sheeting mill and formed into slabs 8 millimeters thick. The slabs were processed into sheets 1.0 and 1.2 millimeters thick. Optionally, two thinner sheets may be laminated into one membrane of the same thickness. A polyamide liner was applied, and the membranes were placed on rolls. The rolls were loaded into a hot air oven to cure under heat

### Example 2—Open Flame Test

In this example, the EPDM membrane of Example 1 was evaluated by direct contact with a single flame. Flame from a torch was held to the membrane for 30 seconds, single frame source test EN 11925-2 class B, C, or D. The membrane glowed red where the flame touched it. However, once the flame was removed, the embers were extinguished immediately. The membrane revealed a burn spot of roughly 10 millimeters by 20 millimeters.

### Example 3—Single Burning Item Test

The EPDM membrane of Example 1 was evaluated using the Single Burning Item (SBI) test (EN 13823). The SBI test measures lateral flame spread, rate of heat release, propensity for the production of flaming drips, and rate of smoke production. A sample of the EPDM membrane was mounted to a vertical surface and placed in a hood. After collecting baseline data, a 30 KW flame impinged on the membrane for 21 minutes. The performance of the membrane was evaluated over a 20 minute period on the factors listed above.

### Example 4—Additional EPDM Rubber Formulas

Additional EPDM rubber formulas are shown in the tables below. The amounts are based on parts per hundred rubber (PHR).

| | | L1735- | L1735- | L1735- | L1735- | L1735- | L1735- | L1735- |
|---|---|---|---|---|---|---|---|---|
| Material | CAS No. | 09-01 | 09-02 | 1x-03 | 19-03 | 09-04 | 09-05 | 09-06 |
| EPDM | 25038-36-2 | 100 | 100 | 100 | | 100 | 100 | 100 |
| INFUSE 9010 | 26221-73-8 | | | | | | | |
| Sulfur | 7704-34-9 | 1.1 | 1.1 | | 0.7 | 0.9 | 0.9 | 0.9 |
| TBzTD | 10591-85-2 | | | | 0.24 | 0.28 | 0.28 | 0.28 |
| CBS | 95-33-0 | 0.58 | 0.58 | | 0.8 | | | |
| TBBS | 95-31-8 | | | | | | | |
| Deovulc BG | 68649-42-3, | 1.1 | 1.1 | | | | | |
| 187 | 120-78-5, | | | | | | | |
| | 102-06-7 | | | | | | | |
| Peroxide 14S | 25155-25-3 | | | | 0.83 | | | |
| 96% | | | | | | | | |
| Zinc Oxide | 1314-13-2 | 3 | 3 | 3 | | 3 | 3 | 3 |
| Stearic acid | 57-11-4 | 1 | 1 | 1 | | 1 | 1 | 1 |
| Polyethylene | 25322-68-3 | | | | | | | |
| glycol | | | | | | | | |
| Resin Escorez | | | | | | | | |
| 1102 | | | | | | | | |
| maleic | | | | | | | | |
| anhydride | | | | | | | | |
| adduct of | | | | | | | | |
| polybutadiene | | | | | | | | |
| Actigran 70 | 3290-92-4 | | | | | | | |
| Carbofoil L- | 12777-87-6 | | | | | | | |
| 120 | | | | | | | | |
| Carbon black | 1333-86-4 | 30 | 30 | 30 | | 25 | 25 | 20 |
| N550 | | | | | | | | |
| DINP | 28553-12-0 | | | | | | | |
| Diisononyl | | | | | | | | |
| phthalate | | | | | | | | |
| tris(2- | 78-42-2 | | | | | | | |
| ethylhexyl) | | | | | | | | |
| phosphate | | | | | | | | |
| WSFR-BDP | >97% | | | | | | | |
| | 5945-33-5, | | | | | | | |
| | 3% | | | | | | | |
| | 115-86-6 | | | | | | | |
| WSFR-CDP | 76% | | | | | | | |
| | 26444-49-5, | | | | | | | |
| | 12% | | | | | | | |
| | 26446-73-1, | | | | | | | |
| | 12% | | | | | | | |
| | 115-86-6, | | | | | | | |
| | 2% | | | | | | | |
| | 1330-78-5 | | | | | | | |
| Paraffinic oil | 64742-65-0 | | 10 | | | | | |
| Aluminum | 21645-51-2 | 200 | 200 | 200 | | 200 | 200 | 200 |
| Hydroxide | | | | | | | | |
| MgH | 1309-42-8 | | | | | | | |
| Zinc borate | 138265-88-0 | | | | | | | |
| Calcium | 1317-65-3 | | | | | | | |
| Carbonate | | | | | | | | |
| TESPT | >50% | | | | | | | |
| | 24937-78-8, | | | | | | | |
| | <50% | | | | | | | |
| | 40372-72-3 | | | | | | | |
| Silica | 7631-86-9 | | | | | | | 8.5 |
| EPFR-100D | 68333-79-9 | | | | | | | |
| EPFR | 218768-84-4 | | | | | | | |
| MPP300 | | | | | | | | |
| Sidistar | 69012-64-2 | | | | | | | |
| R320U | | | | | | | | |
| Resin | 68131-87-1 | | | | | | | |
| Novares TC | | | | | | | | |
| 100 | | | | | | | | |
| Glass fibers | | | | | | | | |
| FG 400/100 | | | | | | | | |
| Glass fibers | | | | | | | | |
| FG 600/100 | | | | | | | | |
| ADK STAB | 60% | | | | | | | |
| FP-2100JC | 66034-17-1, | | | | | | | |
| | 40% | | | | | | | |
| | trade secret | | | | | | | |
| | (phosphoric | | | | | | | |
| | acid | | | | | | | |
| | compound) | | | | | | | |
| China clay/ | 1332-58-7 | | | | | | | |
| Polwhite | E | | | | | | | |

| | | L1735- | L1735- | L1735- | L1735- | L1735- | L1735- | L1735- |
|---|---|---|---|---|---|---|---|---|
| Material | CAS No. | 09-07 | 09-08 | 19-09 | 19-10 | 19-11 | 09-12 | 09-13 |
| EPDM | 25038-36-2 | 100 | 100 | | | | 100 | 100 |
| INFUSE 9010 | 26221-73-8 | | | | | | | |
| Sulfur | 7704-34-9 | 0.9 | 0.9 | | | 0.3 | 0.9 | 0.9 |
| TBzTD | 10591-85-2 | 0.28 | 0.28 | | | 1.6 | 0.28 | 0.28 |
| CBS | 95-33-0 | | | | | 0.4 | 0.56 | 0.56 |
| TBBS | 95-31-8 | | | | | | | |
| Deovulc BG | 68649-42-3, | | | | | | | |
| 187 | 120-78-5, | | | | | | | |
| | 102-06-7 | | | | | | | |
| Peroxide 14S | 25155-25-3 | | | | | | | |
| 96% | | | | | | | | |
| Zinc Oxide | 1314-13-2 | 3 | 3 | | | | 3 | 3 |
| Stearic acid | 57-11-4 | 1 | 1 | | | | 1 | 1 |
| Polyethylene | 25322-68-3 | | | | | | | |
| glycol | | | | | | | | |
| Resin Escorez | | | | | | | | |
| 1102 | | | | | | | | |
| maleic | | | | | | | | |
| anhydride | | | | | | | | |
| adduct of | | | | | | | | |
| polybutadiene | | | | | | | | |
| Actigran 70% | 3290-92-4 | | | | | | | |
| Carbofoil L- | 12777-87-6 | | | | | | | |
| 120 | | | | | | | | |
| Carbon black | 1333-86-4 | 25 | 25 | | | | 50 | 50 |
| N550 | | | | | | | | |
| DINP | 28553-12-0 | | | | | | | |
| Diisononyl | | | | | | | | |
| phthalate | | | | | | | | |
| tris(2- | 78-42-2 | | | | | | | |
| ethylhexyl) | | | | | | | | |
| phosphate | | | | | | | | |
| WSFR-BDP | >97% | | | | | | | |
| | 5945-33-5, | | | | | | | |
| | 3% | | | | | | | |
| | 115-86-6 | | | | | | | |
| WSFR-CDP | 76% | | | | | | | |
| | 26444-49-5, | | | | | | | |
| | 12% | | | | | | | |
| | 26446-73-1, | | | | | | | |
| | 12% | | | | | | | |
| | 115-86-6, | | | | | | | |
| | 2% | | | | | | | |
| | 1330-78-5 | | | | | | | |
| Paraffinic oil | 64742-65-0 | | | | | | 22 | 22 |
| Aluminum | 21645-51-2 | 100 | 100 | | | | 130 | 130 |
| Hydroxide | | | | | | | | |
| MgH | 1309-42-8 | | | | | | | |
| Zinc borate | 138265-88-0 | | | | | | | |
| Calcium | 1317-65-3 | | | | | | | |
| Carbonate | | | | | | | | |
| TESPT | >50% | | | | | | | |
| | 24937-78-8, | | | | | | | |
| | <50% | | | | | | | |
| | 40372-72-3 | | | | | | | |
| Silica | 7631-86-9 | | | | | | | |
| EPFR-100D | 68333-79-9 | 100 | | | | | | |
| EPFR MP300 | 218768-84-4 | | 100 | | | | | |
| Sidistar | 69012-64-2 | | | | | | | |
| R320U | | | | | | | | |
| Resin Novares | 68131-87-1 | | | | | | 3 | 3 |
| TC 100 | | | | | | | | |
| Glass fibers | | | | | | | | 10 |
| FG 400/100 | | | | | | | | |
| Glass fibers | | | | | | | | |
| FG 600/100 | | | | | | | | |
| ADK STAB | 60% | | | | | | | |
| FP-2100JC | 66034-17-1, | | | | | | | |
| | 40% | | | | | | | |
| | trade secret | | | | | | | |
| | (phosphoric | | | | | | | |
| | acid | | | | | | | |
| | compound) | | | | | | | |
| China clay/ | 1332-58-7 | | | | | | | |
| Polwhite E | | | | | | | | |

| | | L1735- | L1735- | L1735- | L1735- | L1735- | L1735- | L1735- |
|---|---|---|---|---|---|---|---|---|
| Material | CAS No. | 09-14 | 09-15 | 09-16 | 09-17 | 19-18 | 19-19 | 1x-20 |
| EPDM | 25038-36-2 | 100 | 100 | 100 | 100 | | | 50 |
| INFUSE 9010 | 26221-73-8 | | | | | | | 50 |
| Sulfur | 7704-34-9 | 0.9 | 0.9 | 0.9 | 0.9 | 0.4 | 1 | |
| TBzTD | 10591-85-2 | 0.28 | 0.28 | 0.28 | 0.28 | 0.4 | 0.8 | |
| CBS | 95-33-0 | 0.56 | 0.56 | 0.56 | 0.56 | 0.4 | 0.8 | |
| TBBS | 95-31-8 | | | | | | | |
| Deovulc BG | 68649-42- | | | | | | | |
| 187 | 3, 120-78- | | | | | | | |
| | 5, 102-06-7 | | | | | | | |
| Peroxide 14S | 25155-25-3 | | | | | | | |
| 96% | | | | | | | | |
| Zinc Oxide | 1314-13-2 | 3 | 3 | 3 | 3 | | | 3 |
| Stearic acid | 57-11-4 | 1 | 1 | 1 | 1 | | | 1 |
| Polyethylene | 25322-68-3 | | | | | | | |
| glycol | | | | | | | | |
| Resin Escorez | | | | | | | | |
| 1102 | | | | | | | | |
| maleic | | | | | | | | |
| anhydride | | | | | | | | |
| adduct of | | | | | | | | |
| polybutadiene | | | | | | | | |
| Actigran 70 | 3290-92-4 | | | | | | | |
| Carbofoil L- | 12777-87-6 | | | | | | | |
| 120 | | | | | | | | |
| Carbon black | 1333-86-4 | 50 | 25 | 25 | 25 | | | 20 |
| N550 | | | | | | | | |
| DINP | 28553-12-0 | | | | | | | |
| Diisononyl | | | | | | | | |
| phthalate | | | | | | | | |
| tris(2- | 78-42-2 | | | | | | | |
| ethylhexyl) | | | | | | | | |
| phosphate | | | | | | | | |
| WSFR-BDP | >97% | | | | | | | |
| | 5945-33-5, | | | | | | | |
| | 3% | | | | | | | |
| | 115-86-6 | | | | | | | |
| WSFR-CDP | 76% | | | | | | | |
| | 26444-49-5, | | | | | | | |
| | 12% | | | | | | | |
| | 26446-73- | | | | | | | |
| | 1, 12% | | | | | | | |
| | 115-86-6, | | | | | | | |
| | 2% | | | | | | | |
| | 1330-78-5 | | | | | | | |
| Paraffinic oil | 64742-65-0 | 22 | | | | | | |
| Aluminum | 21645-51-2 | 130 | 100 | | | | | 100 |
| Hydroxide | | | | | | | | |
| MgH | 1309-42-8 | | | | | | | |
| Zinc borate | 138265-88-0 | | | | | | | |
| Calcium | 1317-65-3 | | | | | | | |
| Carbonate | | | | | | | | |
| TESPT | >50% | | | | | | | |
| | 24937-78-8, | | | | | | | |
| | <50% | | | | | | | |
| | 40372-72-3 | | | | | | | |
| Silica | 7631-86-9 | | | | | | | |
| EPFR-100D | 68333-79-9 | | | | 150 | | | 100 |
| EPFR MP300 | 218768-84-4 | | | | | | | |
| Sidistar | 69012-64-2 | | | | | | | |
| R320U | | | | | | | | |
| Resin | 68131-87-1 | 3 | | | | | | |
| Novares TC | | | | | | | | |
| 100 | | | | | | | | |
| Glass fibers | | | | | | | | |
| FG 400/100 | | | | | | | | |
| Glass fibers | | 10 | | | | | | |
| FG 600/100 | | | | | | | | |
| ADK STAB | 60% | | 100 | 100 | | | | |
| FP-2100JC | 66034-17-1, | | | | | | | |
| | 40% | | | | | | | |
| | trade secret | | | | | | | |
| | (phosphoric | | | | | | | |
| | acid | | | | | | | |
| | compound) | | | | | | | |
| China clay/ | 1332-58-7 | | | 100 | | | | |
| Polwhite E | | | | | | | | |

| | | L1735- | L1735- | L1735- | L1735- | L1735- | L1735- | L1735- |
|---|---|---|---|---|---|---|---|---|
| Material | CAS No. | 19-20 | 1x-21 | 19-21 | 09-22 | 09-23 | 09-24 | 19-25 |
| EPDM | 25038-36-2 | | 75 | | 100 | 100 | 100 | |
| INFUSE 9010 | 26221-73-8 | | 25 | | | | | |
| Sulfur | 7704-34-9 | 0.56 | | 0.83 | 0.9 | 0.9 | 0.9 | |
| TBzTD | 10591-85-2 | 0.22 | | 0.3 | 0.32 | 0.32 | 0.32 | |
| CBS | 95-33-0 | 0.45 | | 0.52 | 0.56 | 0.56 | 0.56 | |
| TBBS | 95-31-8 | | | | | | | |
| Deovulc BG | 68649-42-3, | | | | | | | |
| 187 | 120-78-5, | | | | | | | |
| | 102-06-7 | | | | | | | |
| Peroxide 14 S | 25155-25-3 | | | | | | | |
| 96% | | | | | | | | |
| Zinc Oxide | 1314-13-2 | | 3 | | 3 | 3 | 3 | |
| Stearic acid | 57-11-4 | | 1 | | 1 | 1 | 1 | |
| Polyethylene | 25322-68-3 | | | | 3 | 3 | | |
| glycol | | | | | | | | |
| Resin Escorez | | | | | | | | |
| 1102 | | | | | | | | |
| maleic | | | | | | | | |
| anhydride | | | | | | | | |
| adduct of | | | | | | | | |
| polybutadiene | | | | | | | | |
| Actigran 70 | 3290-92-4 | | | | | | | |
| Carbofoil L- | 12777-87-6 | | | | 5 | | 40 | |
| 120 | | | | | | | | |
| Carbon black | 1333-86-4 | | 20 | | | 5 | 20 | |
| N550 | | | | | | | | |
| DINP | 28553-12-0 | | | | | 7.5 | 7.5 | |
| Diisononyl | | | | | | | | |
| phthalate | | | | | | | | |
| tris(2- | 78-42-2 | | | | | | | |
| ethylhexyl) | | | | | | | | |
| phosphate | | | | | | | | |
| WSFR-BDP | >97% | | | | | | | |
| | 5945-33-5, | | | | | | | |
| | 3% | | | | | | | |
| | 115-86-6 | | | | | | | |
| WSFR-CDP | 76% | | | | | | | |
| | 26444-49-5, | | | | | | | |
| | 12% | | | | | | | |
| | 26446-73-1, | | | | | | | |
| | 12% | | | | | | | |
| | 115-86-6, | | | | | | | |
| | 2% | | | | | | | |
| | 1330-78-5 | | | | | | | |
| Paraffinic oil | 64742-65-0 | | | | | | | |
| Aluminum | 21645-51-2 | | 100 | | 180 | 180 | 160 | |
| Hydroxide | | | | | | | | |
| MgH | 1309-42-8 | | | | | | | |
| Zinc borate | 138265-88-0 | | | | | | | |
| Calcium | 1317-65-3 | | | | | | | |
| Carbonate | | | | | | | | |
| TESPT | >50% | | | | | | | |
| | 24937-78-8, | | | | | | | |
| | <50% | | | | | | | |
| | 40372-72-3 | | | | | | | |
| Silica | 7631-86-9 | | | | 20 | 20 | | |
| EPFR-100D | 68333-79-9 | | 100 | | | | | |
| EPFR MP300 | 218768-84-4 | | | | | | | |
| Sidistar | 69012-64-2 | | | | | | | |
| R320U | | | | | | | | |
| Resin Novares | 68131-87-1 | | | | | | | |
| TC 100 | | | | | | | | |
| Glass fibers | | | | | | | | |
| FG 400/100 | | | | | | | | |
| Glass fibers | | | | | | | | |
| FG 600/100 | | | | | | | | |
| ADK STAB | 60% | | | | | | | |
| FP-2100JC | 66034-17-1, | | | | | | | |
| | 40% | | | | | | | |
| | trade secret | | | | | | | |
| | (phosphoric | | | | | | | |
| | acid | | | | | | | |
| | compound) | | | | | | | |
| China clay/ | 1332-58-7 | | | | | | | |
| Polwhite E | | | | | | | | |

| | | L1735- | L1735- | L1735- | L1735- | L1735- | L1735- | L1735- |
|---|---|---|---|---|---|---|---|---|
| Material | CAS No. | 19-26 | 09-27 | 09-28 | 09-29 | 09-30 | 19-31 | 19-32 |
| EPDM | 25038-36-2 | | 100 | 100 | 100 | 100 | | |
| INFUSE 9010 | 26221-73-8 | | | | | | | |
| Sulfur | 7704-34-9 | | 0.76 | 0.9 | 0.9 | 0.9 | | 0.4 |
| TBzTD | 10591-85-2 | | 0.27 | 0.32 | 0.32 | 0.32 | | 0.16 |
| CBS | 95-33-0 | | 0.6 | 0.56 | 0.56 | 0.56 | | 0.32 |
| TBBS | 95-31-8 | | | | | | | |
| Deovulc BG | 68649-42-3, | | | | | | | |
| 187 | 120-78-5, | | | | | | | |
| | 102-06-7 | | | | | | | |
| Peroxide 14 S | 25155-25-3 | | | | | | | |
| 96% | | | | | | | | |
| Zinc Oxide | 1314-13-2 | | 3 | 3 | | 3 | | |
| Stearic acid | 57-11-4 | | 1 | 1 | | 1 | | |
| Polyethylene | 25322-68-3 | | | | | | | |
| glycol | | | | | | | | |
| Resin Escorez | | | | | | | | |
| 1102 | | | | | | | | |
| maleic | | | | | | | | |
| anhydride | | | | | | | | |
| adduct of | | | | | | | | |
| polybutadiene | | | | | | | | |
| Actigran 70 | 3290-92-4 | | | | | | | |
| Carbofoil L- | 12777-87-6 | | | | | | | |
| 120 | | | | | | | | |
| Carbon black | 1333-86-4 | | 25 | 25 | 25 | 25 | | |
| N550 | | | | | | | | |
| DINP | 28553-12-0 | | | | | | | |
| Diisononyl | | | | | | | | |
| phthalate | | | | | | | | |
| tris(2- | 78-42-2 | | | | | | | |
| ethylhexyl) | | | | | | | | |
| phosphate | | | | | | | | |
| WSFR-BDP | >97% | | 16 | 20 | 20 | 20 | | |
| | 5945-33-5, | | | | | | | |
| | 3% | | | | | | | |
| | 115-86-6 | | | | | | | |
| WSFR-CDP | 76% | | | | | | | |
| | 26444-49-5, | | | | | | | |
| | 12% | | | | | | | |
| | 26446-73-1, | | | | | | | |
| | 12% | | | | | | | |
| | 115-86-6, | | | | | | | |
| | 2% | | | | | | | |
| | 1330-78-5 | | | | | | | |
| Paraffinic oil | 64742-65-0 | | | | | | | |
| Aluminum | 21645-51-2 | | 200 | 200 | 200 | 200 | | |
| Hydroxide | | | | | | | | |
| MgH | 1309-42-8 | | | | | | | |
| Zinc borate | 138265-88-0 | | | | | | | |
| Calcium | 1317-65-3 | | | | | | | |
| Carbonate | | | | | | | | |
| TESPT | >50% | | | | | | | |
| | 24937-78-8, | | | | | | | |
| | <50% | | | | | | | |
| | 40372-72-3 | | | | | | | |
| Silica | 7631-86-9 | | | | | | | |
| EPFR-100D | 68333-79-9 | | | | | | | |
| EPFR MP300 | 218768-84-4 | | | | | | | |
| Sidistar | 69012-64-2 | | | | | | | |
| R320U | | | | | | | | |
| Resin Novares | 68131-87-1 | | | | | | | |
| TC 100 | | | | | | | | |
| Glass fibers | | | | | | | | |
| FG 400/100 | | | | | | | | |
| Glass fibers | | | | | | | | |
| FG 600/100 | | | | | | | | |
| ADK STAB | 60% | | | | | | | |
| FP-2100JC | 66034-17-1, | | | | | | | |
| | 40% | | | | | | | |
| | trade secret | | | | | | | |
| | (phosphoric | | | | | | | |
| | acid | | | | | | | |
| | compound) | | | | | | | |
| China clay/ | 1332-58-7 | | | | | | | |
| Polwhite E | | | | | | | | |

| | | L1735- | L1735- | L1735- | L1735- | L1735- | L1735- | L1735- |
|---|---|---|---|---|---|---|---|---|
| Material | CAS No. | 09-33 | 09-34 | 09-35 | 09-36 | 09-37 | 1x-38 | 19-38 |
| EPDM | 25038-36-2 | 100 | 100 | 100 | 100 | 100 | 100 | |
| INFUSE 9010 | 26221-73-8 | | | | | | | |
| Sulfur | 7704-34-9 | 1.3 | 1 | 1 | 0.9 | 0.9 | | 0.9 |
| TBzTD | 10591-85-2 | 0.48 | 0.4 | 0.4 | 0.32 | 0.32 | | 0.32 |
| CBS | 95-33-0 | 0.88 | 0.6 | 0.6 | 0.56 | 0.56 | | 0.56 |
| TBBS | 95-31-8 | | | | | | | |
| Deovulc BG | 68649-42-3, | | | | | | | |
| 187 | 120-78-5, | | | | | | | |
| | 102-06-7 | | | | | | | |
| Peroxide 14 S | 25155-25-3 | | | | | | | |
| 96% | | | | | | | | |
| Zinc Oxide | 1314-13-2 | 3 | 3 | 3 | 3 | 3 | 3 | |
| Stearic acid | 57-11-4 | 1 | 1 | 1 | 1 | 1 | 1 | |
| Polyethylene | 25322-68-3 | | | | | | | |
| glycol | | | | | | | | |
| Resin Escorez | | | | 5 | 5 | 5 | 3 | |
| 1102 | | | | | | | | |
| maleic | | | | | | | | |
| anhydride | | | | | | | | |
| adduct of | | | | | | | | |
| polybutadiene | | | | | | | | |
| Actigran 70 | 3290-92-4 | | | | | | | |
| Carbofoil L- | 12777-87-6 | | | | | | | |
| 120 | | | | | | | | |
| Carbon black | 1333-86-4 | 25 | 25 | 25 | 25 | 25 | 25 | |
| N550 | | | | | | | | |
| DINP | 28553-12-0 | | | | | | | |
| Diisononyl | | | | | | | | |
| phthalate | | | | | | | | |
| tris(2- | 78-42-2 | | | | | | | |
| ethylhexyl) | | | | | | | | |
| phosphate | | | | | | | | |
| WSFR-BDP | >97% | 20 | 20 | 20 | 20 | 20 | 15 | 10 |
| | 5945-33-5, | | | | | | | |
| | 3% | | | | | | | |
| | 115-86-6 | | | | | | | |
| WSFR-CDP | 76% | | | | | | | |
| | 26444-49-5, | | | | | | | |
| | 12% | | | | | | | |
| | 26446-73-1, | | | | | | | |
| | 12% | | | | | | | |
| | 115-86-6, | | | | | | | |
| | 2% | | | | | | | |
| | 1330-78-5 | | | | | | | |
| Paraffinic oil | 64742-65-0 | | | | | | | |
| Aluminum | 21645-51-2 | 180 | 200 | 200 | 160 | 200 | 100 | 100 |
| Hydroxide | | | | | | | | |
| MgH | 1309-42-8 | | | | | | | |
| Zinc borate | 138265-88-0 | | | | | | | |
| Calcium | 1317-65-3 | | | | | | | |
| Carbonate | | | | | | | | |
| TESPT | >50% | | | | | | | |
| | 24937-78-8, | | | | | | | |
| | <50% | | | | | | | |
| | 40372-72-3 | | | | | | | |
| Silica | 7631-86-9 | | | | | | | |
| EPFR-100D | 68333-79-9 | | | | | | | |
| EPFR MP300 | 218768-84-4 | | | | | | | |
| Sidistar | 69012-64-2 | 20 | | | | | | |
| R320U | | | | | | | | |
| Resin Novares | 68131-87-1 | | | | | | | |
| TC 100 | | | | | | | | |
| Glass fibers | | | | | | | | |
| FG 400/100 | | | | | | | | |
| Glass fibers | | | | | | | | |
| FG 600/100 | | | | | | | | |
| ADK STAB | 60% | | | | | | | |
| FP-2100JC | 66034-17-1, | | | | | | | |
| | 40% | | | | | | | |
| | trade secret | | | | | | | |
| | (phosphoric | | | | | | | |
| | acid | | | | | | | |
| | compound) | | | | | | | |
| China clay/ | 1332-58-7 | | | | | | | |
| Polwhite E | | | | | | | | |

| | | L1735- | L1735- | L1735- | L1735- | L1735- | L1735- | L1735- |
|---|---|---|---|---|---|---|---|---|
| Material | CAS No. | 19-39 | 19-40 | 09-41 | 09-42 | 09-43 | 09-44 | 09-45 |
| EPDM | 25038-36-2 | | | 100 | 100 | 100 | 100 | 100 |
| INFUSE 9010 | 26221-73-8 | | | | | | | |
| Sulfur | 7704-34-9 | 0.4 | 0.4 | 1.3 | 1.08 | 1.08 | 1.08 | 1.08 |
| TBzTD | 10591-85-2 | 0.24 | 0.24 | 0.49 | 0.4 | 0.4 | 0.4 | 0.4 |
| CBS | 95-33-0 | 0.32 | 0.32 | 0.89 | 0.73 | 0.73 | 0.73 | 0.73 |
| TBBS | 95-31-8 | | | | | | | |
| Deovulc BG | 68649-42-3, | | | | | | | |
| 187 | 120-78-5, | | | | | | | |
| | 102-06-7 | | | | | | | |
| Peroxide 14 S | 25155-25-3 | | | | | | | |
| 96% | | | | | | | | |
| Zinc Oxide | 1314-13-2 | | | 3 | 2.5 | 2.5 | 2.5 | 2.5 |
| Stearic acid | 57-11-4 | | | 1 | 0.83 | 0.83 | 0.83 | 0.83 |
| Polyethylene | 25322-68-3 | | | | | | | |
| glycol | | | | | | | | |
| Resin Escorez | | | | | | | | |
| 1102 | | | | | | | | |
| maleic | | | | | | | | |
| anhydride | | | | | | | | |
| adduct of | | | | | | | | |
| polybutadiene | | | | | | | | |
| Actigran 70 | 3290-92-4 | | | | | | | |
| Carbofoil L- | 12777-87-6 | | | | | | | |
| 120 | | | | | | | | |
| Carbon black | 1333-86-4 | | | 24 | 21 | 21 | 21 | 21 |
| N550 | | | | | | | | |
| DINP | 28553-12-0 | | | | | | | |
| Diisononyl | | | | | | | | |
| phthalate | | | | | | | | |
| tris(2- | 78-42-2 | | | | | | | 16.7 |
| ethylhexyl) | | | | | | | | |
| phosphate | | | | | | | | |
| WSFR-BDP | >97% | | | 20 | 16.7 | 16.7 | 16.7 | |
| | 5945-33-5, | | | | | | | |
| | 3% | | | | | | | |
| | 115-86-6 | | | | | | | |
| WSFR-CDP | 76% | | | | | | | |
| | 26444-49-5, | | | | | | | |
| | 12% | | | | | | | |
| | 26446-73-1, | | | | | | | |
| | 12% | | | | | | | |
| | 115-86-6, | | | | | | | |
| | 2% | | | | | | | |
| | 1330-78-5 | | | | | | | |
| Paraffinic oil | 64742-65-0 | | | | | | | |
| Aluminum | 21645-51-2 | | | 165 | 186 | 186 | 186 | 186 |
| Hydroxide | | | | | | | | |
| MgH | 1309-42-8 | | | | | | | |
| Zinc borate | 138265-88-0 | | | | | | 16.7 | 16.7 |
| Calcium | 1317-65-3 | | | | | | | |
| Carbonate | | | | | | | | |
| TESPT | >50% | | | | | | | 4.17 |
| | 24937-78-8, | | | | | | | |
| | <50% | | | | | | | |
| | 40372-72-3 | | | | | | | |
| Silica | 7631-86-9 | | | | | | | |
| EPFR-100D | 68333-79-9 | | | | | | | |
| EPFR MP300 | 218768-84-4 | | | | | | | |
| Sidistar | 69012-64-2 | | | 35 | | | | |
| R320U | | | | | | | | |
| Resin Novares | 68131-87-1 | | | | | | | |
| TC 100 | | | | | | | | |
| Glass fibers | | | | | | | | |
| FG 400/100 | | | | | | | | |
| Glass fibers | | | | | | | | |
| FG 600/100 | | | | | | | | |
| ADK STAB | 60% | | | | | | | |
| FP-2100JC | 66034-17-1, | | | | | | | |
| | 40% | | | | | | | |
| | trade secret | | | | | | | |
| | (phosphoric | | | | | | | |
| | acid | | | | | | | |
| | compound) | | | | | | | |
| China clay/ | 1332-58-7 | | | | | | | |
| Polwhite E | | | | | | | | |

| | | L1735- | L1735- | L1735- | L1735- | L1735- | L1735- | L1735- |
|---|---|---|---|---|---|---|---|---|
| Material | CAS No. | 09-46 | 1x-47 | 19-47 | 1x-48 | 19-48 | 19-49 | 19-50 |
| EPDM | 25038-36-2 | 100 | 100 | | 100 | | | |
| INFUSE 9010 | 26221-73-8 | | | | | | | |
| Sulfur | 7704-34-9 | 1.08 | 1.08 | 1.3 | | 1.3 | 0.9 | 0.45 |
| TBzTD | 10591-85-2 | 0.4 | 0.4 | 0.48 | | 0.48 | 0.32 | 0.16 |
| CBS | 95-33-0 | 0.73 | 0.73 | 0.88 | | 0.88 | 0.56 | 0.28 |
| TBBS | 95-31-8 | | | | | | | |
| Deovulc | 68649-42-3, | | | | | | | |
| BG187 | 120-78-5, | | | | | | | |
| | 102-06-7 | | | | | | | |
| Peroxide 14 S | 25155-25-3 | | | | | | | |
| 96% | | | | | | | | |
| Zinc Oxide | 1314-13-2 | 2.5 | 2.5 | | 3 | | | |
| Stearic acid | 57-11-4 | 0.83 | 0.83 | | 1 | | | |
| Polyethylene | 25322-68-3 | | | | | | | |
| glycol | | | | | | | | |
| Resin Escorez | | | | | | | | |
| 1102 | | | | | | | | |
| maleic | | | | | | | | |
| anhydride | | | | | | | | |
| adduct of | | | | | | | | |
| polybutadiene | | | | | | | | |
| Actigran 70 | 3290-92-4 | | | | | | | |
| Carbofoil L- | 12777-87-6 | | | | | | | |
| 120 | | | | | | | | |
| Carbon black | 1333-86-4 | 21 | 21 | | 20 | | | |
| N550 | | | | | | | | |
| DINP | 28553-12-0 | | | | | | | |
| Diisononyl | | | | | | | | |
| phthalate | | | | | | | | |
| tris(2- | 78-42-2 | 16.7 | 16.7 | | 10 | | | |
| ethylhexyl) | | | | | | | | |
| phosphate | | | | | | | | |
| WSFR-BDP | >97% | | | | | | | |
| | 5945-33-5, | | | | | | | |
| | 3% | | | | | | | |
| | 115-86-6 | | | | | | | |
| WSFR-CDP | 76% | | | | | | | |
| | 26444-49-5, | | | | | | | |
| | 12% | | | | | | | |
| | 26446-73-1, | | | | | | | |
| | 12% | | | | | | | |
| | 115-86-6, | | | | | | | |
| | 2% | | | | | | | |
| | 1330-78-5 | | | | | | | |
| Paraffinic oil | 64742-65-0 | | | | | | | |
| Aluminum | 21645-51-2 | 186 | 186 | | 200 | | | |
| Hydroxide | | | | | | | | |
| MgH | 1309-42-8 | | | | | | | |
| Zinc borate | 138265-88-0 | 16.7 | 16.7 | | 20 | | | |
| Calcium | 1317-65-3 | | | | | | | |
| Carbonate | | | | | | | | |
| TESPT | >50% | 4.17 | | | | | | |
| | 24937-78-8, | | | | | | | |
| | <50% | | | | | | | |
| | 40372-72-3 | | | | | | | |
| Silica | 7631-86-9 | | | | | | | |
| EPFR-100D | 68333-79-9 | | | | | | | |
| EPFR MP300 | 218768-84-4 | | | | | | | |
| Sidistar | 69012-64-2 | | | | | | | |
| R320U | | | | | | | | |
| Resin Novares | 68131-87-1 | | | | | | | |
| TC 100 | | | | | | | | |
| Glass fibers | | | | | | | | |
| FG 400/100 | | | | | | | | |
| Glass fibers | | | | | | | | |
| FG 600/100 | | | | | | | | |
| ADK STAB | 60% | | | | | | | |
| FP-2100JC | 66034-17-1, | | | | | | | |
| | 40% | | | | | | | |
| | trade secret | | | | | | | |
| | (phosphoric | | | | | | | |
| | acid | | | | | | | |
| | compound) | | | | | | | |
| China clay/ | 1332-58-7 | | | | | | | |
| Polwhite E | | | | | | | | |

| | | L1735- | L1735- | L1735- | L1735- | L1735- | L1735- | L1735- |
|---|---|---|---|---|---|---|---|---|
| Material | CAS No. | 1x-51 | 19-51 | 1x-52 | 19-52 | 1x-53 | 19-53 | 19-54 |
| EPDM | 25038-36-2 | 100 | | 100 | | 100 | | |
| INFUSE 9010 | 26221-73-8 | | | | | | | |
| Sulfur | 7704-34-9 | | 0.45 | | 0.6 | | 0.6 | 0.8 |
| TBzTD | 10591-85-2 | | 0.16 | | 0.16 | | 0.16 | 0.24 |
| CBS | 95-33-0 | | 0.28 | | 0.32 | | 0.32 | 0.48 |
| TBBS | 95-31-8 | | | | | | | |
| Deovulc BG | 68649-42-3, | | | | | | | |
| 187 | 120-78-5, | | | | | | | |
| | 102-06-7 | | | | | | | |
| Peroxide 14 S | 25155-25-3 | | | | | | | |
| 96% | | | | | | | | |
| Zinc Oxide | 1314-13-2 | 3 | | 3 | | 3 | | |
| Stearic acid | 57-11-4 | 1 | | 1 | | 1 | | |
| Polyethylene | 25322-68-3 | | | | | | | |
| glycol | | | | | | | | |
| Resin Escorez | | | | | | | | |
| 1102 | | | | | | | | |
| maleic | | 2.1 | | 2.8 | | 2.8 | | |
| anhydride | | | | | | | | |
| adduct of | | | | | | | | |
| polybutadiene | | | | | | | | |
| Actigran 70 | 3290-92-4 | | | | | | | |
| Carbofoil L- | 12777-87-6 | | | | | | | |
| 120 | | | | | | | | |
| Carbon black | 1333-86-4 | 20 | | 20 | | 20 | | |
| N550 | | | | | | | | |
| DINP | 28553-12-0 | | | | | | | |
| Diisononyl | | | | | | | | |
| phthalate | | | | | | | | |
| tris(2- | 78-42-2 | | | 10 | | 10 | | |
| ethylhexyl) | | | | | | | | |
| phosphate | | | | | | | | |
| WSFR-BDP | >97% | | | | | | | |
| | 5945-33-5, | | | | | | | |
| | 3% | | | | | | | |
| | 115-86-6 | | | | | | | |
| WSFR-CDP | 76% | | | | | | | |
| | 26444-49-5, | | | | | | | |
| | 12% | | | | | | | |
| | 26446-73-1, | | | | | | | |
| | 12% | | | | | | | |
| | 115-86-6, | | | | | | | |
| | 2% | | | | | | | |
| | 1330-78-5 | | | | | | | |
| Paraffinic oil | 64742-65-0 | | | | | | | |
| Aluminum | 21645-51-2 | 200 | | 115 | | 230 | | |
| Hydroxide | | | | | | | | |
| MgH | 1309-42-8 | | | 115 | | | | |
| Zinc borate | 138265-88-0 | | | | | | | |
| Calcium | 1317-65-3 | | | | | 10 | | |
| Carbonate | | | | | | | | |
| TESPT | >50% | | | | | | | |
| | 24937-78-8, | | | | | | | |
| | <50% | | | | | | | |
| | 40372-72-3 | | | | | | | |
| Silica | 7631-86-9 | | | | | | | |
| EPFR-100D | 68333-79-9 | | | | | | | |
| EPFR MP300 | 218768-84-4 | | | | | | | |
| Sidistar | 69012-64-2 | 35 | | | | 25 | | |
| R320U | | | | | | | | |
| Resin Novares | 68131-87-1 | | | | | | | |
| TC 100 | | | | | | | | |
| Glass fibers | | | | | | | | |
| FG 400/100 | | | | | | | | |
| Glass fibers | | | | | | | | |
| FG 600/100 | | | | | | | | |
| ADK STAB | 60% | | | | | | | |
| FP-2100JC | 66034-17-1, | | | | | | | |
| | 40% | | | | | | | |
| | trade secret | | | | | | | |
| | (phosphoric | | | | | | | |
| | acid | | | | | | | |
| | compound) | | | | | | | |
| China clay/ | 1332-58-7 | | | | | | | |
| Polwhite E | | | | | | | | |

| | | L1735- | L1735- | L1735- | L1735- | L1735- | L1735- | L1735- |
|---|---|---|---|---|---|---|---|---|
| Material | CAS No. | 1x-55 | 19-55 | 19-56 | 19-57 | 09-58 | 09-59 | 09-60 |
| EPDM | 25038-36-2 | 100 | | | | 100 | 100 | 100 |
| INFUSE 9010 | 26221-73-8 | | | | | | | |
| Sulfur | 7704-34-9 | | 0.8 | | | 0.8 | 0.8 | 0.8 |
| TBzTD | 10591-85-2 | | 0.24 | | | 0.24 | 0.24 | 0.24 |
| CBS | 95-33-0 | | | | | | | |
| TBBS | 95-31-8 | | 0.48 | | | 0.48 | 0.48 | 0.48 |
| Deovulc BG | 68649-42-3, | | | | | | | |
| 187 | 120-78-5, | | | | | | | |
| | 102-06-7 | | | | | | | |
| Peroxide 14 S | 25155-25-3 | | | 3 | | | | |
| 96% | | | | | | | | |
| Zinc Oxide | 1314-13-2 | 3 | | | | 3 | 3 | 3 |
| Stearic acid | 57-11-4 | 1 | | | | 1 | 1 | 1 |
| Polyethylene | 25322-68-3 | | | | | | | |
| glycol | | | | | | | | |
| Resin Escorez | | | | | | | | |
| 1102 | | | | | | | | |
| maleic | | 2.8 | | | | 2.8 | 2.8 | 2.8 |
| anhydride | | | | | | | | |
| adduct of | | | | | | | | |
| polybutadiene | | | | | | | | |
| Actigran 70 | 3290-92-4 | | | 0.75 | | | | |
| Carbofoil L - | 12777-87-6 | | | | | | | |
| 120 | | | | | | | | |
| Carbon black | 1333-86-4 | 20 | | | | 20 | 20 | 20 |
| N550 | | | | | | | | |
| DINP | 28553-12-0 | | | | | | | |
| Diisononyl | | | | | | | | |
| phthalate | | | | | | | | |
| tris(2- | 78-42-2 | | | | | 10 | 10 | 10 |
| ethylhexyl) | | | | | | | | |
| phosphate | | | | | | | | |
| WSFR-BDP | >97% | 20 | | | | | | |
| | 5945-33-5, | | | | | | | |
| | 3% | | | | | | | |
| | 115-86-6 | | | | | | | |
| WSFR-CDP | 76% | | | | | | | |
| | 26444-49-5, | | | | | | | |
| | 12% | | | | | | | |
| | 26446-73-1, | | | | | | | |
| | 12% | | | | | | | |
| | 115-86-6, | | | | | | | |
| | 2% | | | | | | | |
| | 1330-78-5 | | | | | | | |
| Paraffinic oil | 64742-65-0 | | | | | | | |
| Aluminum | 21645-51-2 | 230 | | | | 230 | 230 | 230 |
| Hydroxide | | | | | | | | |
| MgH | 1309-42-8 | | | | | | | |
| Zinc borate | 138265-88-0 | | | | | | | |
| Calcium | 1317-65-3 | | | | | 10 | 10 | 10 |
| Carbonate | | | | | | | | |
| TESPT | >50% | | | | | | | |
| | 24937-78-8, | | | | | | | |
| | <50% | | | | | | | |
| | 40372-72-3 | | | | | | | |
| Silica | 7631-86-9 | | | | | | | |
| EPFR-100D | 68333-79-9 | | | | | | | |
| EPFR MP300 | 218768-84-4 | | | | | | | |
| Sidistar | 69012-64-2 | 25 | | | | 10 | 20 | 30 |
| R320U | | | | | | | | |
| Resin Novares | 68131-87-1 | | | | | | | |
| TC 100 | | | | | | | | |
| Glass fibers | | | | | | | | |
| FG 400/100 | | | | | | | | |
| Glass fibers | | | | | | | | |
| FG 600/100 | | | | | | | | |
| ADK STAB | 60% | | | | | | | |
| FP-2100JC | 66034-17-1, | | | | | | | |
| | 40% | | | | | | | |
| | trade secret | | | | | | | |
| | (phosphoric | | | | | | | |
| | acid | | | | | | | |
| | compound) | | | | | | | |
| China clay/ | 1332-58-7 | | | | | | | |
| Polwhite E | | | | | | | | |

| | | L1735- | L1735- | L1735- | L1735- | L1735- | L1735- | L1735- |
|---|---|---|---|---|---|---|---|---|
| Material | CAS No. | 09-61 | 09-62 | 09-63 | 09-64 | 09-65 | 09-66 | 1x-67 |
| EPDM | 25038-36-2 | 100 | 100 | 100 | 100 | 100 | 100 | 100 |
| INFUSE 9010 | 26221-73-8 | | | | | | | |
| Sulfur | 7704-34-9 | 0.8 | 0.8 | 0.8 | 0.8 | 0.8 | 0.8 | |
| TBzTD | 10591-85-2 | 0.24 | 0.24 | 0.24 | 0.24 | 0.24 | 0.24 | |
| CBS | 95-33-0 | | | | | | | |
| TBBS | 95-31-8 | 0.48 | 0.48 | 0.48 | 0.48 | 0.48 | 0.48 | |
| Deovulc BG | 68649-42-3, | | | | | | | |
| 187 | 120-78-5, | | | | | | | |
| | 102-06-7 | | | | | | | |
| Peroxide 14 S | 25155-25-3 | | | | | | | |
| 96% | | | | | | | | |
| Zinc Oxide | 1314-13-2 | 3 | 3 | 3 | 3 | 3 | 3 | 3 |
| Stearic acid | 57-11-4 | 1 | 1 | 1 | 1 | 1 | 1 | 1 |
| Polyethylene | 25322-68-3 | | | | | | | |
| glycol | | | | | | | | |
| Resin Escorez | | | | | | | | |
| 1102 | | | | | | | | |
| maleic | | 2.8 | 2.8 | 2.8 | 2.8 | 2.8 | 2.8 | 2.8 |
| anhydride | | | | | | | | |
| adduct of | | | | | | | | |
| polybutadiene | | | | | | | | |
| Actigran 70 | 3290-92-4 | | | | | | | |
| Carbofoil L- | 12777-87-6 | | | | | | | |
| 120 | | | | | | | | |
| Carbon black | 1333-86-4 | 20 | 20 | 20 | 20 | 15 | 10 | 20 |
| N550 | | | | | | | | |
| DINP | 28553-12-0 | | | | | | | |
| Diisononyl | | | | | | | | |
| phthalate | | | | | | | | |
| tris(2- | 78-42-2 | 10 | 10 | 10 | 12.5 | 10 | 10 | 20 |
| ethylhexyl) | | | | | | | | |
| phosphate | | | | | | | | |
| WSFR-BDP | >97% | | | | | | | |
| | 5945-33-5, | | | | | | | |
| | 3% | | | | | | | |
| | 115-86-6 | | | | | | | |
| WSFR-CDP | 76% | | | | | | | |
| | 26444-49-5, | | | | | | | |
| | 12% | | | | | | | |
| | 26446-73-1, | | | | | | | |
| | 12% | | | | | | | |
| | 115-86-6, | | | | | | | |
| | 2% | | | | | | | |
| | 1330-78-5 | | | | | | | |
| Paraffinic oil | 64742-65-0 | | | | | | | |
| Aluminum | 21645-51-2 | 230 | 230 | 230 | 260 | 260 | 260 | 230 |
| Hydroxide | | | | | | | | |
| MgH | 1309-42-8 | | | | | | | |
| Zinc borate | 138265-88-0 | | | | | | | |
| Calcium | 1317-65-3 | 10 | 10 | 10 | | | | 10 |
| Carbonate | | | | | | | | |
| TESPT | >50% | | | | | | | |
| | 24937-78-8, | | | | | | | |
| | <50% | | | | | | | |
| | 40372-72-3 | | | | | | | |
| Silica | 7631-86-9 | | | | | | | |
| EPFR-100D | 68333-79-9 | | | | | | | |
| EPFR MP300 | 218768-84-4 | | | | | | | |
| Sidistar | 69012-64-2 | 40 | 50 | | 25 | 17.5 | | 25 |
| R320U | | | | | | | | |
| Resin Novares | 68131-87-1 | | | | | | | |
| TC 100 | | | | | | | | |
| Glass fibers | | | | | | | | |
| FG 400/100 | | | | | | | | |
| Glass fibers | | | | | | | | |
| FG 600/100 | | | | | | | | |
| ADK STAB | 60% | | | | | | | |
| FP-2100JC | 66034-17-1, | | | | | | | |
| | 40% | | | | | | | |
| | trade secret | | | | | | | |
| | (phosphoric | | | | | | | |
| | acid | | | | | | | |
| | compound) | | | | | | | |
| China clay/ | 1332-58-7 | | | | | | 30 | |
| Polwhite E | | | | | | | | |

| | | L1735- | L1735- | L1735- | L1735- | L1735- | L1735- | L1735- |
|---|---|---|---|---|---|---|---|---|
| Material | CAS No. | 19-67 | 1x-68 | 19-68 | 1x-69 | 19-69 | 09-70 | 1x-71 |
| EPDM | 25038-36-2 | | 100 | | 100 | | 100 | 100 |
| INFUSE 9010 | 26221-73-8 | | | | | | | |
| Sulfur | 7704-34-9 | 0.8 | | 0.8 | | 0.8 | 0.8 | |
| TBzTD | 10591-85-2 | 0.24 | | 0.24 | | 0.24 | 0.24 | |
| CBS | 95-33-0 | | | | | | | |
| TBBS | 95-31-8 | 0.48 | | 0.48 | | 0.48 | 0.48 | |
| Deovulc BG | 68649-42-3, | | | | | | | |
| 187 | 120-78-5, | | | | | | | |
| | 102-06-7 | | | | | | | |
| Peroxide 14 S | 25155-25-3 | | | | | | | |
| 96% | | | | | | | | |
| Zinc Oxide | 1314-13-2 | | 3 | | 3 | | 3 | 3 |
| Stearic acid | 57-11-4 | | 1 | | 1 | | 1 | 1 |
| Polyethylene | 25322-68-3 | | | | | | | |
| glycol | | | | | | | | |
| Resin Escorez | | | | | | | | |
| 1102 | | | | | | | | |
| maleic | | | 2.8 | | 2.8 | | 2.8 | 2.8 |
| anhydride | | | | | | | | |
| adduct of | | | | | | | | |
| polybutadiene | | | | | | | | |
| Actigran 70 | 3290-92-4 | | | | | | | |
| Carbofoil L- | 12777-87-6 | | | | | | | |
| 120 | | | | | | | | |
| Carbon black | 1333-86-4 | | 20 | | 20 | | 10 | 10 |
| N550 | | | | | | | | |
| DINP | 28553-12-0 | | | | | | | |
| Diisononyl | | | | | | | | |
| phthalate | | | | | | | | |
| tris(2- | 78-42-2 | | | | | | 20 | 20 |
| ethylhexyl) | | | | | | | | |
| phosphate | | | | | | | | |
| WSFR-BDP | >97% | | 20 | | | | | |
| | 5945-33-5, | | | | | | | |
| | 3% | | | | | | | |
| | 115-86-6 | | | | | | | |
| WSFR-CDP | 76% | | | | 20 | | | |
| | 26444-49-5, | | | | | | | |
| | 12% | | | | | | | |
| | 26446-73-1, | | | | | | | |
| | 12% | | | | | | | |
| | 115-86-6, | | | | | | | |
| | 2% | | | | | | | |
| | 1330-78-5 | | | | | | | |
| Paraffinic oil | 64742-65-0 | | | | | | | |
| Aluminum | 21645-51-2 | | 230 | | 230 | | 260 | 260 |
| Hydroxide | | | | | | | | |
| MgH | 1309-42-8 | | | | | | | |
| Zinc borate | 138265-88-0 | | | | | | | |
| Calcium | 1317-65-3 | | 10 | | 10 | | | |
| Carbonate | | | | | | | | |
| TESPT | >50% | | | | | | | |
| | 24937-78-8, | | | | | | | |
| | <50% | | | | | | | |
| | 40372-72-3 | | | | | | | |
| Silica | 7631-86-9 | | | | | | | |
| EPFR-100D | 68333-79-9 | | | | | | | |
| EPFR MP300 | 218768-84-4 | | | | | | | |
| Sidistar | 69012-64-2 | | 25 | | 25 | | | |
| R320U | | | | | | | | |
| Resin | 68131-87-1 | | | | | | | |
| Novares TC | | | | | | | | |
| 100 | | | | | | | | |
| Glass fibers | | | | | | | | |
| FG 400/100 | | | | | | | | |
| Glass fibers | | | | | | | | |
| FG 600/100 | | | | | | | | |
| ADK STAB | 60% | | | | | | | |
| FP-2100JC | 66034-17-1, | | | | | | | |
| | 40% | | | | | | | |
| | trade secret | | | | | | | |
| | (phosphoric | | | | | | | |
| | acid | | | | | | | |
| | compound) | | | | | | | |
| China clay/ | 1332-58-7 | | | | | 25 | 30 | |
| Polwhite E | | | | | | | | |

| | | L1735- | L1735- | L1735- | L1735- | L1735- | L1735- | L1735- |
|---|---|---|---|---|---|---|---|---|
| Material | CAS No. | 19-72 | 09-72 | 09-73 | 09-74 | 09-75 | 19-76 | 09-77 |
| EPDM | 25038-36-2 | | 100 | 100 | 100 | 100 | | 100 |
| INFUSE 9010 | 26221-73-8 | | | | | | | |
| Sulfur | 7704-34-9 | 0.8 | 0.9 | 0.9 | 0.9 | 0.9 | | 0.9 |
| TBzTD | 10591-85-2 | 0.24 | 0.32 | 0.32 | 0.32 | 0.32 | | 0.32 |
| CBS | 95-33-0 | 0.42 | 0.56 | 0.56 | 0.56 | 0.56 | | 0.56 |
| TBBS | 95-31-8 | | | | | | | |
| Deovulc BG | 68649-42-3, | | | | | | | |
| 187 | 120-78-5, | | | | | | | |
| | 102-06-7 | | | | | | | |
| Peroxide 14S | 25155-25-3 | | | | | | | |
| 96% | | | | | | | | |
| Zinc Oxide | 1314-13-2 | | 3 | 3 | 3 | 3 | | 3 |
| Stearic acid | 57-11-4 | | 1 | 1 | 1 | 1 | | 1 |
| Polyethylene | 25322-68-3 | | | | | | | |
| glycol | | | | | | | | |
| Resin Escorez | | | | | | | | |
| 1102 | | | | | | | | |
| maleic | | | 2.8 | 2.8 | 2.8 | 2.8 | | 2.8 |
| anhydride | | | | | | | | |
| adduct of | | | | | | | | |
| polybutadiene | | | | | | | | |
| Actigran 70 | 3290-92-4 | | | | | | | |
| Carbofoil L- | 12777-87-6 | | 35 | 35 | 20 | 10 | | 20 |
| 120 | | | | | | | | |
| Carbon black | 1333-86-4 | | 20 | 20 | 20 | 20 | | 20 |
| N550 | | | | | | | | |
| DINP | 28553-12-0 | | | | | | | |
| Diisononyl | | | | | | | | |
| phthalate | | | | | | | | |
| tris(2- | 78-42-2 | | 20 | 20 | 20 | 20 | | 20 |
| ethylhexyl) | | | | | | | | |
| phosphate | | | | | | | | |
| WSFR-BDP | >97% | | | | | | | |
| | 5945-33-5, | | | | | | | |
| | 3% | | | | | | | |
| | 115-86-6 | | | | | | | |
| WSFR-CDP | 76% | | | | | | | |
| | 26444-49-5, | | | | | | | |
| | 12% | | | | | | | |
| | 26446-73-1, | | | | | | | |
| | 12% | | | | | | | |
| | 115-86-6, | | | | | | | |
| | 2% | | | | | | | |
| | 1330-78-5 | | | | | | | |
| Paraffinic oil | 64742-65-0 | | | | | | | |
| Aluminum | 21645-51-2 | | 170 | 130 | 120 | 200 | | 180 |
| Hydroxide | | | | | | | | |
| MgH | 1309-42-8 | | | | | | | |
| Zinc borate | 138265-88-0 | | | | | | | |
| Calcium | 1317-65-3 | | | | | | | |
| Carbonate | | | | | | | | |
| TESPT | >50% | | | | | | | |
| | 24937-78-8, | | | | | | | |
| | <50% | | | | | | | |
| | 40372-72-3 | | | | | | | |
| Silica | 7631-86-9 | | | | | | | |
| EPFR-100D | 68333-79-9 | | | 80 | 120 | | | |
| EPFR MP300 | 218768-84-4 | | | | | | | |
| Sidistar | 69012-64-2 | | | | | | | |
| R320U | | | | | | | | |
| Resin Novares | 68131-87-1 | | | | | | | |
| TC 100 | | | | | | | | |
| Glass fibers | | | | | | | | |
| FG 400/100 | | | | | | | | |
| Glass fibers | | | | | | | | |
| FG 600/100 | | | | | | | | |
| ADK STAB | 60% | | | | | | | |
| FP-2100JC | 66034-17-1, | | | | | | | |
| | 40% | | | | | | | |
| | trade secret | | | | | | | |
| | (phosphoric | | | | | | | |
| | acid | | | | | | | |
| | compound) | | | | | | | |
| China clay/ | 1332-58-7 | | | | | | | |
| Polwhite E | | | | | | | | |

| Material | CAS No. | 84970-09-03 |
|---|---|---|
| EPDM | 25038-36-2 | 100 |
| INFUSE 9010 | 26221-73-8 | |
| Sulfur | 7704-34-9 | 0.9 |
| TBzTD | 10591-85-2 | 0.32 |
| CBS | 95-33-0 | 0.56 |
| TBBS | 95-31-8 | |
| Deovulc BG 187 | 68649-42-3, | |
| | 120-78-5, | |
| | 102-06-7 | |
| Peroxide 14S 96% | 25155-25-3 | |
| Zinc Oxide | 1314-13-2 | 3 |
| Stearic acid | 57-11-4 | 1 |
| Polyethylene | 25322-68-3 | |
| glycol | | |
| Resin Escorez 1102 | | |
| maleic anhydride adduct | | 2.8 |
| of polybutadiene | | |
| Actigran 70 | 3290-92-4 | |
| Carbofoil L-120 | 12777-87-6 | 20 |
| Carbon black N550 | 1333-86-4 | 20 |
| DINP Diisononyl | 28553-12-0 | |
| phthalate | | |
| tris(2-ethylhexyl) | 78-42-2 | 20 |
| phosphate | | |
| WSFR-BDP | >97% 5945-33-5, | |
| | 3% 115-86-6 | |
| WSFR-CDP | 76% 26444-49-5, | |
| | 12% 26446-73-1, | |
| | 12% 115-86-6, | |
| | 2% 1330-78-5 | |
| Paraffinic oil | 64742-65-0 | |
| Aluminum Hydroxide | 21645-51-2 | 180 |
| MgH | 1309-42-8 | |
| Zinc borate | 138265-88-0 | |
| Calcium Carbonate | 1317-65-3 | |
| TESPT | >50% 24937-78-8, | |
| | <50% 40372-72-3 | |
| Silica | 7631-86-9 | |
| EPFR-100D | 68333-79-9 | |
| EPFR MP300 | 218768-84-4 | |
| Sidistar R320U | 69012-64-2 | |
| Resin Novares TC 100 | 68131-87-1 | |
| Glass fibers FG 400/100 | | |
| Glass fibers FG 600/100 | | |
| ADK STAB FP-2100JC | 60% 66034-17-1, | |
| | 40% trade secret | |
| | (phosphoric acid | |
| | compound) | |
| China clay/Polwhite E | 1332-58-7 | |

### Example 5—Evaluation of the Formulations

Select formulations from Example 4 were evaluated for physical properties and preliminary flame resistance testing. The results are summarized in the tables below (“MR” is the minimum requirement).

| | | | L1735- | L1735- | L1735- | L1735- |
|---|---|---|---|---|---|---|
| Property | Unit | MR | 09-01 | 09-02 | 19-03 | 09-04 |
| Vulcanizing | | | 22 h/ | 22 h/ | 22 h/ | 22 h/ |
| | | | 135° C. | 135° C. | 135° C. | 135° C. |
| | | | RH oven | RH oven | RH oven | RH oven |
| Rheo | ML | | 1.45 | 0.99 | 2.92 | 1.27 |
| 3′/190° C. | | | | | | |
| Thickness | mm | | 0.70 | 0.73 | 0.72 | 0.61 |
| Density | kg/l | | 1.4707 | 1.4409 | 1.484 | 1.490 |
| Hardness | °Sh A | | 72 | 70 | 75 | 77 |
| Tensile | Mpa | >3 | 4.3 | 3.7 | 3.3 | 4.7 |
| strength S3 | | | | | | |
| Elongation | % | >200 | 406 | 404 | 247 | 427 |
| at break | | | | | | |
| Tear | N/ | >6 | 4.2 | 3.1 | 4.4 | 4.9 |
| resistance | mm | | | | | |
| trouser | | | | | | |
| Aging | | | 7 d/ | 7 d/ | 7 d/ | 7 d/ |
| | | | 100° C. | 100° C. | 100° C. | 100° C. |
| Hardness | °Sh A | | 75 | 75 | 78 | |
| Tensile | Mpa | >3 | 3.7 | 3.8 | 3.9 | |
| strength S3 | | | | | | |
| Elongation | % | >200 | 319 | 298 | 248 | |
| at break | | | | | | |
| 0.6 mm | s | >30 | 0.70 mm | 0.73 mm | | |
| class E free | | | no flame | 59 | | |
| hanging | | | | | | |
| 0.6 mm | s | >60 | 0.74 mm | 0.73 mm | | |
| Class B free | | | 63 | 45 | | |
| hanging | | | | | | |
| result | | >30 | 0.70 mm | 0.73 mm | | |
| class E | | | no flame | 62 | | |
| | | | | 0.72 mm | | |
| | | | | 56 | | |
| result | | >60 | 0.74 mm | 0.73 mm | | |
| Class B | | | 1:04 limit | 50 | | |
| | | | 0.70 mm | 0.74 mm | | |
| | | | 1:08 limit | 40 | | |
| | | | 0.77 mm | 0.72 mm | | |
| | | | 56 | 46 | | |

| Property | Unit | MR | L1735-09-04 | L1735-09-05 | L1735-09-05 |
|---|---|---|---|---|---|
| Vulcanizing | | | Press plate 1 | 22 h/135° C. | Press plate 1 |
| | | | mm | RH oven | mm |
| | | | 2 h/170° C. | | 2 h/170° C. |
| Rheo 3′/190° C. | ML | | 1.27 | 1.75 | |
| Thickness | mm | | | | |
| Density | kg/l | | 1.519 | 1.491 | 1.522 |
| Hardness | ° Sh A | | 88 | 77 | 88 |
| Tensile strength S3 | Mpa | >3 | 5.9 | 4.7 | 6.1 |
| Elongation at break | % | >200 | 557 | 420 | 612 |
| Tear resistance trouser | N/mm | >6 | 11.0 | 5.4 | 14.1 |
| Aging | | | 7 d/100° C. | 7 d/100° C. | 7 d/100° C. |
| Hardness | ° Sh A | | X | 78 | x |
| Tensile strength S3 | Mpa | >3 | X | 4.7 | x |
| Elongation at break | % | >200 | X | 330 | x |
| 0.6 mm class E free | | | | | |
| hanging | | | | | |
| 0.6 mm Class B free | | | | | |
| hanging | | | | | |
| result class E | | | | | |
| result Class B | | | | | |

| Property | Unit | MR | L1735-09-05 | L1739-09-08 |
|---|---|---|---|---|
| Vulcanizing | | | Press plate | Press plate |
| | | | 1 mm | 1 mm |
| | | | 2 h/170° C. | 2 h/170° C. |
| Rheo 3′/190° C. | ML | | | 2.56 |
| Thickness | mm | | | |
| Density | kg/l | | | |
| Hardness | ° ShA | >3 | | |
| Tensile strength S3 | Mpa | >200 | | |
| Elongation at break | % | >6 | | |
| Tear resistance | N/mm | | | |
| trouser | | | | |
| Aging | | | 7 d/100° C. | 7 d/100° C. |
| Hardness | ° Sh A | | | |
| Tensile strength S3 | Mpa | >3 | | |
| Elongation at break | % | >200 | | |
| 0.6 mm class E free | | | | |
| hanging | | | | |
| 0.6 mm class B free | | | | |
| hanging | | | | |
| result class E | | | | |
| result Class B | Thickness | | 1.13 | 1.11 |
| | mm | | | |
| | 150 mm | >60 | 90 s | 40 s extinguish |
| | height | | | |
| | flame | | | |

| | | | L1735- | L1735- | L1735- | L1739- |
|---|---|---|---|---|---|---|
| Property | Unit | MR | 09-05 | 09-06 | 09-07 | 09-08 |
| Vulcanizing | | | 22 h/ | 22 h/ | 22 h/ | 22 h/ |
| | | | 135° C. | 135° C. | 135° C. | 135° C. |
| | | | hot air | hot air | hot air | hot air |
| | | | oven | oven | oven | oven |
| Rheo | ML | | 1.75 | 2.85 | 1.57 | 2.56 |
| 3′/190° C. | | | | | | |
| Thickness | mm | | | | | |
| Density | kg/l | | 1.475 | 1.495 | 1.413 | 1.399 |
| Hardness | °Sh A | | 79 | 77 | 77 | 78 |
| Tensile | Mpa | >3 | 5.2 | 4.9 | 2.4 | 2.9 |
| strength | | | | | | |
| S3 | | | | | | |
| Elongation | % | >200 | 451 | 555 | 585 | 469 |
| at break | | | | | | |
| Tear | N/mm | >6 | 4.3 | 8.2 | 7.5 | 7.5 |
| resistance | | | | | | |
| trouser | | | | | | |
| Aging | | | 7 d/ | 7 d/ | 7 d/ | 7 d/ |
| | | | 100° C. | 100° C. | 100° C. | 100° C. |
| Hardness | °Sh A | | | | | |
| Tensile | Mpa | >3 | | | | |
| strength | | | | | | |
| S3 | | | | | | |
| Elongation | % | >200 | | | | |
| at break | | | | | | |
| 0.6 mm | | | | | | |
| class E | | | | | | |
| free hanging | | | | | | |
| 0.6 mm | | | | | | |
| Class B | | | | | | |
| free hanging | | | | | | |
| result class E | | | | | | |
| result Class B | Thick- | | 0.65 | 0.63 | 0.64 | 0.60 |
| | ness | | | | | |
| | mm | | | | | |
| | 150 mm | >60 | 50 s | 50 s | extinguish | 60 s |
| | height | | | | 10 s after | |
| | flame | | | | removal | |
| | | | | | flame | |
| | | | | | At 20 | |
| | | | | | minutes | |
| | | | | | flame | |
| | | | | | under foil, | |
| | | | | | no | |
| | | | | | extinguish | |
| | | | | | able spread | |
| | | | | | of flame | |
| | | | | | and | |
| | | | | | extinguish | |
| | | | | | imme- | |
| | | | | | diately | |
| | | | | | after | |
| | | | | | flame | |
| | | | | | removal | |

| | | | L1735- | L1735- | L1735- | L1735- |
|---|---|---|---|---|---|---|
| Property | Unit | MR | 19-09 | 19-10 | 09-07 | 19-11 |
| Vulcanizing | | | 22 h/ | 22 h/ | 22 h/ | 22 h/ |
| | | | 135° C. | 135° C. | 135° C. | 135° C. |
| | | | hot air | hot air | hot air | hot air |
| | | | oven | oven | oven | oven |
| Rheo | ML | | | | | |
| 3′/190° C. | | | | | | |
| Thickness | mm | | 0.80 | 0.71 | | |
| Density | kg/l | | 1.457 | 1.441 | | 1.400 |
| Hardness | °Sh A | | 79 | 79 | | 80 |
| Tensile | Mpa | >3 | 4 | 3.9 | | 3.9 |
| strength S3 | | | | | | |
| Elongation | % | >200 | 500 | 495 | | 441 |
| at break | | | | | | |
| Tear | N/mm | >6 | 10.5 | 9.3 | | 4.7 |
| resistance | | | | | | |
| trouser | | | | | | |
| Aging | | | 7 d/ | 7 d/ | 7 d/ | 7 d/ |
| | | | 100° C. | 100° C. | 100° C. | 100° C. |
| Hardness | °Sh A | | | | | 81 |
| Tensile | Mpa | >3 | | | | 4.4 |
| strength S3 | | | | | | |
| Elongation | % | >200 | | | | 384 |
| at break | | | | | | |
| 0.6 mm | | | | | | |
| class E | | | | | | |
| free | | | | | | |
| hanging | | | | | | |
| 0.6 mm | | | | | | |
| Class B | | | | | | |
| free | | | | | | |
| hanging | | | | | | |
| result | | | | | | |
| class E | | | | | | |
| result | Thick- | | 0.80 | 0.71 | 0.72 | 0.72 |
| Class B | ness | | | | | |
| | mm | | | | | |
| | 150 | >60 | 55 s | extin- | imme- | reaches |
| | mm | | | guish | diately | the line |
| | height | | | at 35 s | extin- | of 150 |
| | flame | | | | guish | mm at |
| | | | | | at 35 s | 55 s |
| | | | | | re- | |
| | | | | | moving | |
| | | | | | flame | |
| | | | | With | | |
| | | | | contin- | | |
| | | | | uous | | |
| | | | | flame | | |
| | | | | at 65 | | |
| | | | | seconds, | | |
| | | | | 150 | | |
| | | | | mm is | | |
| | | | | reached | | |

| Property | Unit | MR | L1735-09-12 | L1735-09-13 | L1735-09-14 |
|---|---|---|---|---|---|
| Vulcanizing | | | 22 h/135° C. | 22 h/135° C. | 22 h/135° C. |
| | | | hot air oven | hot air oven | hot air oven |
| Rheo 3′/190° C. | ML | | 0.93 | 1.01 | 1.01 |
| Thickness | mm | | | | |
| Density | kg/l | | 1.332 | 1.340 | 1.339 |
| Hardness | ° Sh A | | 70 | 72 | 72 |
| Tensile strength S3 | Mpa | >3 | 6.4 | 5.4 | 5.4 |
| Elongation at break | % | >200 | 465 | 417 | 420 |
| Tear resistance trouser | N/mm | >6 | 7.5 | 6.5 | 5.8 |
| Aging | | | 7 d/100° C. | 7 d/100° C. | 7 d/100° C. |
| Hardness | ° Sh A | | 70 | 74 | 74 |
| Tensile strength S3 | Mpa | >3 | 5.7 | 5.2 | 5.2 |
| Elongation at break | % | >200 | 394 | 356 | 349 |
| 0.6 mm class E free | | >30 | | | |
| hanging | | | | | |
| 0.6 mm Class B free | | >60 | | | |
| hanging | | | | | |
| | Thickness | | 0.70 | 0.73 | 0.61 |
| | mm | | | | |
| result class E | length | >30 | 26 s | 30 s | 32 s |
| | cross | | 30 s | 32 s | 32 s |
| result Class B | Thickness | | | | |
| | mm | | | | |
| | 150 mm | | | | |
| | height | | | | |
| | flame | | | | |

| | | | L1735- | L1735- | L1735- | L1735- |
|---|---|---|---|---|---|---|
| Property | Unit | MR | 19-15 | 19-16 | 09-17 | 19-18 |
| Vulcanizing | | | 22 h/ | 22 h/ | 22 h/ | 22 h/ |
| | | | 135° C. | 135° C. | 135° C. | 135° C. |
| | | | hot air | hot air | hot air | hot air |
| | | | oven | oven | oven | oven |
| Rheo | ML | | | | 2.00 | |
| 3′/190° C. | | | | | | |
| Thickness | mm | | 0.68 | 0.68 | 0.72 | |
| Density | kg/l | | 1.386 | 1.409 | 1.272 | |
| Hardness | °Sh A | | 77 | 80 | 74 | |
| Tensile | Mpa | >3 | 4.0 | 3.9 | 2.0 | |
| strength S3 | | | | | | |
| Elongation | % | >200 | 420 | 398 | 596 | |
| at break | | | | | | |
| Tear | N/mm | >6 | 4.2 | 7.2 | 10.0 | |
| resistance | | | | | | |
| trouser | | | | | | |
| Aging | | | 7 d/ | 7 d/ | 7 d/ | 7 d/ |
| | | | 100° C. | 100° C. | 100° C. | 100° C. |
| Hardness | °Sh A | | 80 | 84 | 78 | |
| Tensile | Mpa | >3 | 3.8 | 3.9 | 1.9 | |
| strength S3 | | | | | | |
| Elongation | % | >200 | 375 | 345 | 285 | |
| at break | | | | | | |
| 0.6 mm | s | >30 | | | | |
| class E | | | | | | |
| free hanging | | | | | | |
| 0.6 mm | s | >60 | | | | |
| Class B | | | | | | |
| free hanging | | | | | | |
| result class E | | | | | | |
| result Class | Thick- | | 0.68 | 0.67 | 0.72 | |
| B | ness | | 0.67 | 0.70 | 0.73 | |
| | mm | | | | | |
| | 150 | >60 | 45s | 35 s | after | |
| | mm | | extin- | 35 s | 30 s | |
| | height | | guish | | flame | |
| | flame | | 45 s | | extin- | |
| | | | | | guish | |
| | | | | | imme- | |
| | | | | | diately | |
| result Class | Thick- | | About | | | |
| B | ness | | vulcanized | | | |
| | mm | | 0.70 mm | | | |
| | 150 | | 55 s, | | | |
| | mm | | slightly | | | |
| | height | | better | | | |
| | flame | | so as a | | | |
| | | | vulcanized | | | |
| | | | flame also | | | |
| | | | seems less | | | |
| | | | intense | | | |

| | | | L1735- | L1735- | L1735- | L1735- |
|---|---|---|---|---|---|---|
| Property | Unit | MR | 19-20 | 19-21 | 09-22 | 09-23 |
| Vulcanizing | | | 22 h/ | 22 h/ | 22 h/ | 22 h/ |
| | | | 135° C. | 135° C. | 135° C. | 135° C. |
| | | | hot air | hot air | hot air | hot air |
| | | | oven | oven | oven | oven |
| Rheo | ML | | | | 3.39 | 3.44 |
| 3′/190° C. | | | | | | |
| Thickness | mm | | | | | |
| Density | kg/l | | 1.422 | 1.450 | 1.463 | 1.447 |
| Hardness | °Sh A | | 81 | 81 | 79 | 74 |
| Tensile | Mpa | >3 | 2.2 | 2.1 | 5.3 | 5.6 |
| strength S3 | | | | | | |
| Elongation | % | >200 | 17 | 134 | 605 | 577 |
| at break | | | | | | |
| Tear | N/mm | >6 | 10.5 | 7.4 | 10.6 | 7.7 |
| resistance | | | | | | |
| trouser | | | | | | |
| Aging | | | 7 d/ | 7 d/ | 7 d/ | 7 d/ |
| | | | 100° C. | 100° C. | 100° C. | 100° C. |
| Hardness | °Sh A | | x | x | | |
| Tensile | Mpa | >3 | x | x | | |
| strength S3 | | | | | | |
| Elongation | % | >200 | x | x | | |
| at break | | | | | | |
| 1.0 mm | Thick- | | | | 0.99 | 0.95 |
| Class B | ness | | | | | |
| free | mm | | | | | |
| hanging | | | | | | |
| | time | >60 | | | 90 s | 55 s |
| | | | | | 55 s | 65 s |
| | | | | | 1 mm | 1 mm |
| | | | | | pers | pers |
| | | | | | 15′/ | 15′/ |
| | | | | | 170° C. | 170° C. |
| small | Thick- | | 0.68 | 0.72 | 1.05 | 1.15 |
| burning | ness | | | | | |
| test | mm | | | | | |
| 30/30 | | | | | | |
| | 150 | >60 | 33 | 46 | 90 | 150 |
| | mm | | 46 | 49 | seconds | second |
| | height | | | | at | extin- |
| | flame | | | | the | guish. |
| | | | | | mark | Was very |
| | | | | | | small |
| | | | | | | flame |
| result | Thick- | | | this | | |
| Class B | ness | | | property | | |
| | mm | | | also tested | | |
| | | | | unvul- | | |
| | | | | canized | | |
| | | | | on fire. | | |
| | | | | Curls up | | |
| | | | | strongly | | |
| | | | | and | | |
| | | | | burns too | | |

| Property | Unit | MR | L1735-09-24 | L1735-19-25 | L1735-19-26 |
|---|---|---|---|---|---|
| Vulcanizing | | | 22 h/135° C. | 22 h/135° C. | 22 h/135° C. |
| | | | hot air oven | hot air oven | hot air oven |
| Rheo 3′/190° C. | ML | | 0.76 | | |
| Thickness | mm | | | | |
| Density | kg/l | | 1.401 | 1.402 | 1.436 |
| Hardness | ° Sh A | | 73 | 77 | 77 |
| Tensile strength S3 | Mpa | >3 | 2.1 | 2.6 | 2.8 |
| Elongation at break | % | >200 | 278 | 329 | 371 |
| Tear resistance | N/mm | >6 | 3.7 | 6.1 | 6.2 |
| trouser | | | | | |
| Aging | | | 7 d/100° C. | 7 d/100° C. | 7 d/100° C. |
| Hardness | ° Sh A | | x | x | x |
| Tensile strength S3 | Mpa | >3 | x | x | x |
| Elongation at break | % | >200 | x | x | x |
| 1.0 mm Class B free | Thickness | | 1.00 | 1.14 | 1.10 |
| hanging | mm | | | 1.18 | 1.08 |
| | time | >60 | after 30 s | drip 70 s | drip no |
| | | | direct | top 100 s | top 100 s |
| | | | extinguish | drip no | drip 60 s |
| | | | | top 90 s | top 110s |
| | | | 1 mm pers | 1 mm pers | |
| | | | 15′/170° C. | 15′/170° C. | |
| result Class B | Thickness | | 1.10 | 1.10 | 1.10 |
| | mm | | | | |
| | 150 mm | | immediately | after 40 s | after 110 s |
| | height | | extinguish | extinguish | extinguish |
| | flame | | after 30S | very small | very small |
| | | | | flame | flame |

| | | | L1735- | L1735- | L1735- | L1735- | L1735- |
|---|---|---|---|---|---|---|---|
| Property | Unit | MR | 09-27 | 09-28 | 09-29 | 09-30 | 19-31 |
| Vulcan- | | | 22 h/ | 22 h/ | 22 h/ | 22 h/ | 22 h/ |
| izing | | | 135° C. | 135° C. | 135° C. | 135° C. | 135° C. |
| | | | hot air | hot air | hot air | hot air | hot air |
| | | | oven | oven | oven | oven | oven |
| Rheo 3′/ | ML | | 1.25 | 1.70 | 1.81 | 1.95 | |
| 190° C. | | | | | | | |
| Thick- | mm | | | | | | |
| ness | | | | | | | |
| Density | kg/l | | 1.490 | 1.491 | 1.483 | 1.492 | 1.482 |
| Hard- | °Sh A | | 79 | 80 | 78 | 77 | 79 |
| ness | | | | | | | |
| Tensile | Mpa | >3 | 3.5 | 3.3 | 2.7 | 2.9 | 3.4 |
| strength | | | | | | | |
| S3 | | | | | | | |
| Elon- | % | >200 | 383 | 550 | 524 | 584 | 507 |
| gation | | | | | | | |
| at break | | | | | | | |
| Tear | N/ | >6 | 3.3 | 9.8 | 12.9 | 8.9 | 12.2 |
| resis- | mm | | | | | | |
| tance | | | | | | | |
| trouser | | | | | | | |
| Aging | | | 7 d/ | 7 d/ | 7 d/ | 7 d/ | 7 d/ |
| | | | 100° C. | 100° C. | 100° C. | 100° C. | 100° C. |
| Hard- | °Sh A | | x | x | | | |
| ness | | | | | | | |
| Tensile | Mpa | >3 | x | x | | | |
| strength | | | | | | | |
| S3 | | | | | | | |
| Elon- | % | >200 | x | x | | | |
| gation | | | | | | | |
| at break | | | | | | | |
| 1.0 mm | Thick- | | 1.05 | 1.02 | 1.02 | 1.05 | 0.95 |
| Class | ness | | | 1.05 | 1.02 | 1.05 | 0.95 |
| B free | mm | | | | | | |
| hanging | time | >60 | 70 s | 88 s | 100 s | 70 s | 49 s |
| | | | 70 s | 90 s | 90 s | 80 s | 54 s |
| | | | no drip | no drip | no | no | no |
| | | | 1 mm | 1 mm | drip | drip | drip |
| | | | pers | pers | | | |
| | | | 15′/ | 15′/ | | | |
| | | | 170° C. | 170° C. | | | |
| result | Thick- | | 1.15 | | | | |
| Class | ness | | | | | | |
| B | mm | | | | | | |
| | 150 | | na | | | | |
| | mm | | 110 s | | | | |
| | height | | top no | | | | |
| | flame | | drip | | | | |

| | | | L1735- | L1735- | L1735- | L1735- |
|---|---|---|---|---|---|---|
| Property | Unit | MR | 19-32 | 09-33 | 09-34 | 09-35 |
| Vulcanizing | | | 22 h/ | 22 h/ | | |
| | | | 135° C. | 135° C. | | |
| | | | hot air | hot air | | |
| | | | oven | oven | | |
| Rheo | ML | | | 1.85 | 2.56 | 2.4 |
| 3′/190° C. | | | | | | |
| Thickness | mm | | | | | |
| Density | kg/l | | 1.474 | 1.470 | | |
| Hardness | °Sh A | | 78 | 82 | | |
| Tensile | Mpa | >3 | 4.4 | 4.9 | | |
| strength S3 | | | | | | |
| Elongation | % | >200 | 525 | 443 | | |
| at break | | | | | | |
| Tear | N/mm | >6 | 8.3 | 8.0 | | |
| resistance | | | | | | |
| trouser | | | | | | |
| Aging | | | 7 d/ | 7 d/ | 7 d/ | 7 d/ |
| | | | 100° C. | 100° C. | 100° C. | 100° C. |
| Hardness | °Sh A | | 83 | 84 | | |
| Tensile | Mpa | >3 | 4.1 | 4.6 | | |
| strength S3 | | | | | | |
| Elongation | % | >200 | 465 | 399 | | |
| at break | | | No drip | No drip | | |
| 1.0 mm | Thick- | | 1.08 | 1.08 | | |
| Class B | ness | | 1.05 | 1.06 | | |
| free hanging | mm | | | | | |
| | Time | | 90 | 90 | | |
| | s | | 80 | 80 | | |
| | | | No drip | No drip | | |
| | | | L1735- | L1735- | L1735- | L1735- |
| Property | Unit | MR | 19-36 | 09-37 | 09-38 | 09-39 |
| Vulcanizing | | | 22 h/ | 22 h/ | 22 h/ | 22 h/ |
| | | | 135° C. | 135° C. | 135° C. | 135° C. |
| | | | hot air | hot air | hot air | hot air |
| | | | oven | oven | oven | oven |
| Rheo | ML | | 1.32 | 1.53 | 1.34 | 1.2 |
| 3′/190° C. | | | | | | |
| Thickness | mm | | 1.00 | 0.95 | | |
| Density | kg/l | | 1.413 | 1.473 | 1.476 | 1.465 |
| Hardness | °Sh A | | 78 | 76 | 73 | 73 |
| Tensile | Mpa | >3 | 3.8 | 3.2 | 2.3 | 3.3 |
| strength S3 | | | | | | |
| Elongation | % | >200 | 554 | 577 | 606 | 519 |
| at break | | | | | | |
| Tear | N/mm | >6 | 9.7 | 9.3 | 6.4 | 7.6 |
| resistance | | | | | | |
| trouser | | | | | | |
| Aging | | | 7 d/ | 7 d/ | 7 d/ | 7 d/ |
| | | | 100° C. | 100° C. | 100° C. | 100° C. |
| Hardness | °Sh A | | 81 | 83 | 80 | 80 |
| Tensile | Mpa | >3 | 3.9 | 3.3 | 2.7 | 3.7 |
| strength S3 | | | | | | |
| Elongation | % | >200 | 493 | 506 | 540 | 467 |
| at break | | | | | | |
| 1.0 mm | Thick- | | 1.00 | 0.95 | 0.95 | 1.05 |
| Class B | ness | | 1.00 | 0.97 | | |
| free hanging | mm | | | | | |
| | Time | | 55 s | 70 s | 80 s | 80 s |
| | s | | 55 s | 65 s | 60 s | 84 s |
| | | | no drip | no drip | no drip | no drip |

| Property | Unit | MR | L1735-09-40 | 84970-19-01 | L1735-09-41 |
|---|---|---|---|---|---|
| Vulcanizing | | | 22 h/135° C. | 22 h/135° C. | 2 2h/135° C. |
| | | | hot air oven | hot air oven | hot air oven |
| Rheo 3′/190° C. | ML | | | | |
| Thickness | mm | | | | |
| Density | kg/l | | | 1.512 | 1.474 |
| Hardness | ° Sh A | | 80 | 80 | 85 |
| Tensile strength S3 | Mpa | >3 | 4.0 | 3.5 | 3.1 |
| Elongation at break | % | >200 | 381 | 425 | 310 |
| Tear resistance trouser | N/mm | >6 | 4.8 | 4.9 | 3.6 |
| Aging | | | 7 d/100° C. | 7 d/100° C. | 7 d/100° C. |
| Hardness | ° Sh A | | | | 87 |
| Tensile strength S3 | Mpa | >3 | | 3.5 | 4.3 |
| Elongation at break | % | >200 | | 355 | 334 |
| 1.0 mm Class B free | Thickness | | | 1.10 | 1.00 |
| hanging | mm | | | 1.10 | 1.00 |
| | Time s | | | 100 s | 79 s |
| | | | | 100 s | 68 s |

| | | | L1735- | L1735- | L1735- | L1735- |
|---|---|---|---|---|---|---|
| Property | Unit | MR | 09-42 | 09-43 | 09-44 | 09-45 |
| Vulcanizing | | | 22 h/ | 22 h/ | 22 h/ | 22 h/ |
| | | | 135° C. | 135° C. | 135° C. | 135° C. |
| | | | hot air | hot air | hot air | hot air |
| | | | oven | oven | oven | oven |
| Rheo | ML | | | | | |
| 3′/190° C. | | | | | | |
| Thickness | mm | | | | | |
| Density | kg/l | | 1.417 | 1.390 | 1.435 | 1.421 |
| Hardness | °Sh A | | 80 | 70 | 72 | 72 |
| Tensile | Mpa | >3 | 3.6 | 4.0 | 3.8 | 3.8 |
| strength S3 | | | | | | |
| Elongation | % | >200 | 469 | 318 | 300 | 308 |
| at break | | | | | | |
| Tear | N/mm | >6 | 7.8 | 1.2 | 1.3 | 1.3 |
| resistance | | | | | | |
| trouser | | | | | | |
| Aging | | | 7 d/ | 7 d/ | 7 d/ | 7 d/ |
| | | | 100° C. | 100° C. | 100° C. | 100° C. |
| Hardness | °Sh A | | 80 | 70 | 73 | 72 |
| Tensile | Mpa | >3 | 3.7 | 2.5 | 3.4 | 3.5 |
| strength S3 | | | | | | |
| Elongation | % | >200 | 436 | 209 | 278 | 270 |
| at break | | | | | | |
| 1.0 mm | Thick- | | 1.11 | 1.10 | 1.00 | 1.03 |
| Class B | ness | | 1.15 | 1.09 | 1.01 | 1.01 |
| free | mm | | | | | |
| hanging | | | | | | |
| | Time | | 70 | 54 | 55 | 45 |
| | s | | 75 | 45 | 65 | 45 |

| | | | L1735- | L1735- | L1735- | L1748- |
|---|---|---|---|---|---|---|
| Property | Unit | MR | 09-46 | 19-47 | 19-48 | 19-49 |
| Vulcanizing | | | 22 h/ | 22 h/ | 22 h/ | 22 h/ |
| | | | 135° C. | 135° C. | 135° C. | 135° C. |
| | | | hot air | hot air | hot air | hot air |
| | | | oven | oven | oven | oven |
| Rheo | ML | | | | | |
| 3′/190° C. | | | | | | |
| Thickness | mm | | | | | |
| Density | kg/l | | 1.417 | 1.419 | 1.503 | 1.504 |
| Hardness | °Sh A | | 69 | 71 | 79 | 79 |
| Tensile | Mpa | >3 | 2.8 | 3.2 | 4.8 | 4.7 |
| strength S3 | | | | | | |
| Elongation | % | >200 | 282 | 308 | 274 | 303 |
| at break | | | | | | |
| Tear | N/mm | >6 | 1.0 | 1.1 | 2.3 | 2.9 |
| resistance | | | | | | |
| trouser | | | | | | |
| Aging | | | 7 d/ | 7 d/ | 7 d/ | 7 d/ |
| | | | 100° C. | 100° C. | 100° C. | 100° C. |
| Hardness | °Sh A | | 70 | 71 | 80 | 80 |
| Tensile | Mpa | >3 | 2.7 | 3.1 | 3.8 | 3.9 |
| strength S3 | | | | | | |
| Elongation | % | >200 | 257 | 287 | 241 | 283 |
| at break | | | | | | |
| 1.0 mm | Thick- | | 0.98 | 0.98 | 1.00 | 1.00 |
| Class B | ness | | 0.98 | 0.96 | 0.98 | 1.00 |
| free | mm | | 0.98 | | | |
| hanging | | | | | | |
| | Time | | 45 | 45 | 80 | 80 |
| | s | | 52 | 53 | 78 | 83 |

| | | | L1735- | L1735- | L1735- | L1735- |
|---|---|---|---|---|---|---|
| Property | Unit | MR | 19-50 | 19-51 | 19-52 | 19-54 |
| Vulcanizing | | | 22 h/ | 22 h/ | 22 h/ | 22 h/ |
| | | | 135° C. | 135° C. | 135° C. | 135° C. |
| | | | hot air | hot air | hot air | hot air |
| | | | oven | oven | oven | oven |
| Rheo | ML | | | | | 1.95 |
| 3′/190° C. | | | | | | |
| Thickness | mm | | | | | |
| Density | kg/l | | 1.500 | 1.523 | 1.494 | 1.553 |
| Hardness | °Sh A | | 79 | 85 | 79 | 85 |
| Tensile | Mpa | >3 | 5.7 | 3.9 | 2.9 | 3.8 |
| strength S3 | | | | | | |
| Elongation | % | >200 | 517 | 60 | 544 | 309 |
| at break | | | | | | |
| Tear | N/mm | >6 | 10.9 | 13.9 | 12.6 | 13.3 |
| resistance | | | | | | |
| trouser | | | | | | |
| Aging | | | 7 d/ | 7 d/ | 7 d/ | 7 d/ |
| | | | 100° C. | 100° C. | 100° C. | 100° C. |
| Hardness | °Sh A | | 81 | 86 | 82 | 86 |
| Tensile | Mpa | >3 | 5 | 4.2 | 2.2 | 4.1 |
| strength S3 | | | | | | |
| Elongation | % | >200 | 472 | 55 | 257 | 122 |
| at break | | | | | | |
| 1.0 mm | Thick- | | 1.02 | 0.97 | 1.07 | 1.14 |
| Class B | ness | | 1.02 | 0.97 | 1.07 | 1.11 |
| free hanging | mm | | | | | |
| | Time | | 85 | 78 | 82 | 88 |
| | s | | 83 | 80 | 84 | 88 |

| | | | L1735- | L1735- | L1735- |
|---|---|---|---|---|---|
| Property | Unit | MR | 19-55 | 19-56 | 19-57 |
| | | | Sulfur | Peroxide | Peroxide |
| Rheo | ML | | | | |
| 3′/190° C. | | | | | |
| Thickness | mm | | | | |
| Density | kg/l | | 1.541 | | 1.542 |
| Hardness | °Sh A | | 87 | | 79 |
| Tensile | Mpa | >3 | 2.9 | | 1.6 |
| strength S3 | | | | | |
| Elongation | % | >200 | 28 | | 20 |
| at break | | | | | |
| Tear | N/mm | >6 | 13.9 | | 9.3 |
| resistance | | | | | |
| trouser | | | | | |
| Aging | | | 7 d/ | 7 d/ | 7 d/ |
| | | | 100° C. | 100° C. | 100° C. |
| Hardness | °Sh A | | 86 | | 82 |
| Tensile | Mpa | >3 | 3.3 | | 2.3 |
| strength S3 | | | | | |
| Elongation | % | >200 | 28 | | 24 |
| at break | | | | | |
| 1.0 mm | Thick- | | 1.05 | | 1.12 |
| Class B free | ness | | 1.05 | | 1.12 |
| hanging | mm | | | | |
| | Time | | 110 | | 80 |
| | s | | 84 | | 108 |
| | | | 97 | | 94 |

| | | | L1735- | L1735- | L1735- | L1735- |
|---|---|---|---|---|---|---|
| Property | Unit | MR | 09-58 | 09-59 | 09-60 | 09-61 |
| | | | 10 phr | 10 phr | 10 phr | 10 phr |
| | | | TOF | TOF | TOF | TOF |
| | | | 10 phr | 20 phr | 30 phr | 40 phr |
| | | | Sidistar | Sidistar | Sidistar | Sidistar |
| Rheo | ML | | 1.87 | 1.99 | 2.20 | 2.34 |
| 3′/190° C. | | | | | | |
| Thickness | mm | | | | | |
| Density | kg/l | | 1.538 | 1.548 | 1.563 | 1.575 |
| Hardness | °Sh A | | 83 | 85 | 87 | 87 |
| Tensile | Mpa | >3 | 4.1 | 4.0 | 3.8 | 4.0 |
| strength S3 | | | | | | |
| Elongation | % | >200 | 407 | 258 | 37 | 39 |
| at break | | | | | | |
| Tear | N/ | >6 | 15.1 | 15.5 | 14.6 | 13.1 |
| resistance | mm | | | | | |
| trouser | | | | | | |
| Aging | | | 7 d/ | 7 d/ | 7 d/ | 7 d/ |
| | | | 100° C. | 100° C. | 100° C. | 100° C. |
| Hardness | °Sh A | | 85 | 86 | 87 | 88 |
| Tensile | Mpa | >3 | 3.9 | 4 | 4.2 | 4.4 |
| strength S3 | | | | | | |
| Elongation | % | >200 | 161 | 233 | 36 | 38 |
| at break | | | | | | |
| 1.0 mm | Thick- | | 1.04 | 1.03 | 1.02 | 1.08 |
| Class B | ness | | | | | |
| free | mm | | 1.03 | 1.04 | 0.98 | 1.09 |
| hanging | | | | | | |
| | Time | | 63 | 73 | 81 | 85 |
| | s | | 73 | 73 | 78 | 86 |
| | | average | 68 | 73 | 80 | 86 |

| | | | L1735- | L1735- | L1735- | L1735 |
|---|---|---|---|---|---|---|
| Property | Unit | MR | 09-62 | 09-63 | 09-64 | -09-65 |
| | | | 10 phr | 10 phr | 25 phr | 17.5 phr |
| | | | TOF | TOF | Sidistar | Sidistar, |
| | | | 50 phr | 0 phr | 12.5 phr | 15 phr |
| | | | Sidistar | Sidistar | TOF | N330 ipv |
| | | | | | | 20 and 10 |
| | | | | | | phr TOF |
| Rheo | ML | | 2.62 | 1.62 | 2.19 | 1.93 |
| 3′/190° C. | | | | | | |
| Thickness | mm | | | | | |
| Density | kg/l | | 1.576 | 1.523 | 1.566 | 1.5586 |
| Hardness | °Sh A | | 88 | 84 | 86 | 86 |
| Tensile | Mpa | >3 | 3.8 | 3.9 | 3.95 | 3.9 |
| strength S3 | | | | | | |
| Elongation | % | >200 | 37 | 405 | 39 | 34 |
| at break | | | | | | |
| Tear | N/mm | >6 | 11.6 | 13.6 | 13.9 | 14.1 |
| resistance | | | | | | |
| trouser | | | | | | |
| Aging | | | 7 d/ | 7 d/ | 7 d/ | 7 d/ |
| | | | 100° C. | 100° C. | 100° C. | 100° C. |
| Hardness | °Sh A | | 88 | 85 | 87 | 87 |
| Tensile | Mpa | >3 | 4.3 | 3.7 | 4.7 | 3.7 |
| strength S3 | | | | | | |
| Elongation | % | >200 | 38 | 257 | 38 | 34 |
| at break | | | | | | |
| 1.0 mm | Thick- | | 1.08 | 1.02 | 0.96 | 0.98 |
| Class B free | ness | | 1.08 | 1.02 | 0.98 | 1.00 |
| hanging | mm | | | | | |
| | Time | | 81 | 65 | 78 | 88 |
| | s | | 88 | 80 | 90 | 86 |
| | | | 85 | 73 | 84 | 87 |

| | | | L1735- | L1735- | L1735- | L1735- |
|---|---|---|---|---|---|---|
| Property | Unit | MR | 09-66 | 19-67 | 19-68 | 19-69 |
| | | | 30 phr | L1735- | L1735- | L1735- |
| | | | Polwhite | 19-54 | 19-54 | 19-54 |
| | | | 0 phr | with 20 | with 20 | with 20 |
| | | | Sidistar | phr | phr | phr |
| | | | 10 phr | TOF | BDP | CDP |
| | | | TOF | | | |
| | | | 10 phr | | | |
| | | | N330 | | | |
| Vulcan- | | | 22 h/ | 22 h/ | 22 h/ | 22 h/ |
| izing | | | 135° C. | 135° C. | 135° C. | 135° C. |
| | | | boiler | boiler | boiler | boiler |
| Rheo | ML | | 1.92 | 1.25 | 1.77 | 1.48 |
| 3′/190° C. | | | | | | |
| Thickness | mm | | | | | |
| Density | kg/l | | 1.597 | 1.5351 | 1.5622 | 1.5538 |
| Hardness | °Sh A | | 87 | 85 | 88 | 88 |
| Tensile | Mpa | >3 | 3.8 | 3.6 | 3.1 | 3.3 |
| strength | | | | | | |
| S3 | | | | | | |
| Elongation | % | >200 | 30 | 346 | 21 | 27 |
| at break | | | | | | |
| Tear | N/ | >6 | 15.7 | 12 | 12.9 | 16.5 |
| resistance | mm | | | | | |
| trouser | | | | | | |
| Aging | | | 7 d/ | 7 d/ | 7 d/ | 7 d/ |
| | | | 100° C. | 100° C. | 100° C. | 100° C. |
| Hardness | °Sh A | | | | | |
| Tensile | Mpa | >3 | | | | |
| strength | | | | | | |
| S3 | | | | | | |
| Elongation | % | >200 | | | | |
| at break | | | | | | |
| 1.0 mm | Thick- | | 0.98 | 1.04 | 1.06 | 1.08 |
| Class B | ness | | 1.00 | 1.00 | 1.08 | 1.06 |
| free | mm | | | | | |
| hanging | | | | | | |
| | Time | | 96 | 88 | 90 | 91 |
| | s | | 101 | 78 | 90 | 95 |
| | | | 98 | 83 | 90 | 93 |

| Property | Unit | MR | L1735-09-70 | L1735-09-71 |
|---|---|---|---|---|
| | | | 25 phr Polwhite | |
| | | | 20 phr TOF | |
| | | | 10 phr N330 | |
| Vulcanizing | | | 22 h/135° C. | 22 h/135° C. |
| | | | boiler | boiler |
| Rheo 3′/190° C. | ML | | 1.06 | |
| Thickness | mm | | | |
| Density | kg/l | | 1.560 | 1.55 |
| Hardness | ° Sh A | | 86 | 84 |
| Tensile strength S3 | Mpa | >3 | 3.3 | 2.7 |
| Elongation at break | % | >200 | 37 | 40 |
| Tear resistance trouser | N/mm | >6 | 13.6 | 14.5 |
| Aging | | | 7 d/100° C. | 7 d/100° C. |
| Hardness | ° Sh A | | | |
| Tensile strength S3 | Mpa | >3 | | |
| Elongation at break | % | >200 | | |
| 1.0 mm Class B free | Thickness | | 1.05 | 1.06 |
| hanging | mm | | 1.06 | 1.09 |
| | Time s | | 90 | 95 |
| | | | 96 | 94 |
| | | | 93 | 94 |

| Pro- | | | L1735- | L1735- | L1735- | L1735- | L1735- |
|---|---|---|---|---|---|---|---|
| perty | Unit | MR | 09-72 | 19-73 | 19-74 | 09-75 | 09-76 |
| | | | Carbo- | Carbo- | Carbo- | Carbo- | Carbo- |
| | | | foil | foil | foil | foil | foil |
| | | | 35 phr | 35 phr | 35 phr | 10 phr | 22.5 |
| | | | ATH | ATH | ATH | ATH | phr |
| | | | 170 phr | 130 phr | 120 phr | 200 phr | ATH |
| | | | TOF 20 | EPFR | EPFR | TOF | 185 phr |
| | | | phr | 80 phr | 120 phr | 20 phr | TOF |
| | | | | TOF | TOF | | 20 phr |
| | | | | 20 phr | 20 phr | | |
| Vulcan- | | | 22 h/ | 22 h/ | 22 h/ | 22 h/ | 22 h/ |
| izing | | | 135° C. | 135° C. | 135° C. | 135° C. | 135° C. |
| | | | boiler | boiler | boiler | boiler | boiler |
| Rheo 3′/ | ML | | | | | | |
| 190° C. | | | | | | | |
| Thick- | mm | | | | | | |
| ness | | | | | | | |
| Density | kg/l | | 1.430 | 1.43 | 1.43 | 1.45 | 1.44 |
| Hard- | °Sh A | | 78 | 82 | 83 | 77 | 77 |
| ness | | | | | | | |
| Tensile | Mpa | >3 | 3.2 | 2.2 | 2.5 | 3.7 | 3.1 |
| strength | | | | | | | |
| S3 | | | | | | | |
| Elon- | % | >200 | 265 | 43 | 36 | 417 | 352 |
| gation | | | | | | | |
| at | | | | | | | |
| break | | | | | | | |
| Tear | N/ | >6 | 9.5 | 11.4 | 11.9 | 9.1 | 9.1 |
| resis- | mm | | | | | | |
| tance | | | | | | | |
| trouser | | | | | | | |
| Aging | | | 7 d/ | 7 d/ | 7 d/ | 7 d/ | 7 d/ |
| | | | 100° C. | 100° C. | 100° C. | 100° C. | 100° C. |
| Hard- | °Sh A | | | | | 78 | 77 |
| ness | | | | | | | |
| Tensile | Mpa | >3 | | | | 3.6 | 3.6 |
| strength | | | | | | | |
| S3 | | | | | | | |
| Elon- | % | >200 | | | | 282 | 285 |
| gation | | | | | | | |
| at | | | | | | | |
| break | | | | | | | |
| 1.0 mm | Thick- | | 1.10 | 1.06 | 1.10 | 1.00 | 0.95 |
| Class | ness | | 1.14 | 1.06 | 1.10 | 1.00 | 0.95 |
| B free | mm | | | | | | |
| hang- | | | | | | | |
| ing | | | | | | | |
| | Time | | imme- | imme- | imme- | 220 s | flame |
| | s | | diately | diately | diately | 205 s | out |
| | | | off | off | off | | at |
| | | | after | after | after | | 32 s |
| | | | re- | re- | re- | | |
| | | | moving | moving | moving | | |
| | | | the | the | the | | |
| | | | flame | flame | flame | | |
| | | | | | | 212 s | |

| Property | Unit | MR | 84970-09-03 |
|---|---|---|---|
| Vulcanizing | | | 22 h/135° C. boiler |
| Rheo 3′/190° C. | ML | | 1.71 |
| Thickness | mm | | |
| Density | kg/l | | |
| Hardness | ° Sh A | | |
| Tensile strength S3 | Mpa | >3 | |
| Elongation at break | % | >200 | |
| Tear resistance trouser | N/mm | >6 | |
| Aging | | | 7 d/100° C. |
| Hardness | ° Sh A | | |
| Tensile strength S3 | Mpa | >3 | |
| Elongation at break | % | >200 | |
| 1.0 mm Class B free hanging | Thick-ness | | 1.06 |
| | mm | | 1.01 |
| | Time s | | Right out 205 sec |
| | | | First sample went out |
| | | | immediately and second |
| | | | burned very slowly |

| | | 84970-09-03 production compound with Carbofoil 20 | |
|---|---|---|---|
| Formula | Unit | phr, TOF 20 phr, Carbon black 20 phr and ATH 180 phr. | |
| | | Create 2.2 m² sheet by | Same, but second sample |
| | | vulcanizing 22 cm | vulcanized |
| | | wide strips of lab roll | |
| | | in production 1 mm | |
| | | thick | |
| Vulcanizing | | oven 22 h 135° C. | |
| Rheo 3′/190° C. | ML | 1.71 | |
| Thickness | mm | 1.00 | 1.23 |
| Density | kg/l | 1.430 | 1.430 |
| Hardness | ° Sh A | 79 | 82 |
| Tensile strength S3 | Mpa | 4.4 | 4.1 |
| Elongation at break | % | 307 | 286 |
| Tear resistance trouser | N/mm | 14.2 | 13.5 |

After aging 7 d/100° C.

| | | | |
|---|---|---|---|
| Hardness | ° Sh A | | 85 |
| Tensile strength S3 | Mpa | | 4.8 |
| Elongation at break | % | | 220 |
| 1.0 mm Class B free | Thickness | 1.06 | |
| hanging | mm | 1.01 | |
| | time s | direct extinguish | |
| | | 205 sec | |
| Remarks | | First sample | |
| | | extinguished | |
| | | immediately and | |
| | | second burned very | |
| | | slowly | |

| Formula | Unit | L1735-09-77 | L1735-09-78 |
|---|---|---|---|
| | | Carbofoil | Carbofoil |
| | | 20 Sidistar | 25 Sidistar |
| | | 25 ATH 180 phr | 15 ATH 180 phr |
| | | TOF 20 phr | TOF 20 phr |
| Vulcanizing | | oven 22 h 135° C. | |
| | | on hot mill calendering till 1 mm | |
| Rheo 3′/190° C. | ML | 1.83 | |
| Thickness | mm | 0.97 | 0.99 |
| Density | kg/l | 1.440 | 1.430 |
| Hardness | ° Sh A | 75 | 77 |
| Tensile strength S3 | Mpa | 2.9 | 3.2 |
| Elongation at break | % | 276 | 272 |
| Tear resistance trouser | N/mm | 12.8 | 10.2 |

After aging 7 d/100° C.

| | | | |
|---|---|---|---|
| Hardness | | 8.2 | |
| Tensile strength S3 | Mpa | | 4 |
| Elongation at break | % | | 166 |
| 1.0 mm Class B free | Thickness | 1.00 | 0.99 |
| hanging | mm | 1.00 | 0.99 |
| | time s | 272 | direct |
| | | 262 | extinguish |
| | | | 150 sec |

| Formula | Unit | LD1735-9-01 | LD1735-9-02 | LD1735-9-03 |
|---|---|---|---|---|
| | | formula 328893 | formula 328893 | formula 328893 |
| | | Sulfur 0.90 phr | Sulfur 1.20 phr | Sulfur 1.40 phr |
| | | TBBS 80 0.70 phr | CBS 80 1.00 phr | CBS 80 1.20 phr |
| | | TBzTD 70 0.40 phr | TBzTD 70 0.60 phr | TBzTD 70 0.80 phr |
| Vulcanizing | | oven 22 h 135° C. | | |
| | | on hot mill calendering till 1 mm | | |
| Rheo 3′/190° C. | ML | too slow cure | | |
| Thickness | mm | | 1.15 | 1.14 |
| Density | kg/l | | 1.40 | 1.40 |
| Hardness | ° Sh A | | 68 | 69 |
| Tensile strength S3 | Mpa | | 4.7 | 4.7 |
| Elongation at break | % | | 289 | 211 |
| Tear resistance trouser | N/mm | | 4.0 | 2.6 |

After aging 7 d/100° C.

| | | | | |
|---|---|---|---|---|
| Hardness | ° Sh A | | 69 | 69 |
| Tensile strength S3 | Mpa | | 4.2 | 4.8 |
| Elongation at break | % | | 166 | 198 |
| 1.0 mm Class B free | Thickness | | 1.15 | 1.14 |
| hanging. | mm | | | |
| Needed > 60 s | time s | first sample | 48 | 58 |
| | | second sample | 40 | 48 |

| | |
|---|---|
| remarks | crunches and pieces fall down |
| | burning |

| Formula | Unit | LD1735-9-04 | LD1735-9-05 | LD1735-9-06 |
|---|---|---|---|---|
| | | formula 328893 | formula 328893 | formula 328893 |
| | | Sulfur 1.20 phr | Sulfur 1.00 phr | Sulfur 0.90 phr |
| | | CBS 80 1.00 phr | CBS 80 1.00 phr | CBS 800.80 phr |
| | | TBzTD 70 0.60 phr | TBzTD 70 0.50 phr | TBzTD 70 0.50 phr |
| | | 30 phr par oil | 30 phr par oil | 30 phr par oil |
| Vulcanizing | | oven 22 h 135° C. | | |
| | | on hot mill calendering till 1 mm | | |
| Rheo 3′/190° C. | ML | | | |
| Thickness | mm | 1.00 | 1.06 | 0.99 |
| Density | kg/l | 1.470 | 1.480 | 1.480 |
| Hardness | ° Sh A | 76 | 76 | 75 |
| Tensile strength S3 | Mpa | 5.3 | 5.3 | 5.3 |
| Elongation at break | % | 96 | 95 | 82 |
| Tear resistance | N/mm | 3.4 | 3.6 | 4.3 |
| trouser | | | | |

After aging 7 d/100° C.

| | | | | |
|---|---|---|---|---|
| Hardness | ° Sh A | 77 | 77 | 75 |
| Tensile strength S3 | Mpa | 5.5 | 5.3 | 5.2 |
| Elongation at break | % | 99 | 103 | 98 |
| 1.0 mm Class B free | Thickness | 1.00 | 1.06 | 0.99 |
| hanging. | mm | | | |
| Needed > 60 s | time s | 53* | 82 | 68 |
| | | 60 | 63 | 72 |
| Remark | | *flame burner | | |
| | | was too big | | |

| Formula | Unit | LD1735-9-07 | LD1735-9-08 | LD1735-9-09 | LD1735-9-10 |
|---|---|---|---|---|---|
| | | formula 328893 | formula 328893 | formula 328893 | formula 328893 |
| | | Sulfur 0.90 phr | Sulfur 0.80 phr | Sulfur 0.80 phr | Sulfur 0.60 phr |
| | | CBS 80 0.80 phr | TBBS 80 0.70 phr | TBBS 80 0.70 | TBBS 80 0.50 |
| | | TBzTD 70 0.50 phr | TBzTD 70 0.40 phr | TBzTD 70 0.40 | TBzTD 70 0.30 |
| | | 30 phr par oil | 30 phr par oil | 30 phr par oil | 30 phr par oil |
| | | | | Nordel 4520 20 | Nordel 4520 20 |
| | | | | Nordel 4725 20 | Nordel 4725 20 |
| Vulcanizing | | oven 22 h 135° C. | | | |
| | | on hot mill calendering till 1 mm | | | |
| Rheo 3′/190° C. | ML | 1.91 | 1.86 | 1.89 | 1.78 |
| Thickness | mm | 1.10 | 1.09 | 1.12 | 1.08 |
| Density | kg/l | 1.470 | 1.470 | 1.470 | 1.480 |
| Hardness | ° Sh A | 76 | 75 | 75 | 73 |
| Tensile strength S3 | Mpa | 4.0 | 3.9 | 3.9 | 3.8 |
| Elongation at break | % | 103 | 104 | 100 | 369 |
| Tear resistance trouser | N/mm | 3.4 | 4.4 | 5.1 | 13.2 |

After aging 7 d/100° C.

| | | |
|---|---|---|
| Hardness | ° Sh A | |
| Tensile strength S3 | Mpa | |
| Elongation at break | % | |
| 1.0 mm Class B free | Thickness | 1.02 |
| hanging. | mm | 1.08 |
| Needed > 60 s | time s | 64 |
| | | 64 |

| | | Carlisle | Carlisle | DOW | DOW |
|---|---|---|---|---|---|
| | | 84970-09-04 | 84970-09-04 | 86570-09-01 | 86570-09-01 |
| Formula | Unit | 1.0 mm | 1.2 mm | 1.0 mm | 1.2 mm |
| | | | | formula 328893 | |
| | | | | Sulfur 0.60 phr | |
| | | | | TBBS 80 0.50 | |
| | | | | TBzTD 70 0.30 | |
| | | | | 30 phr par oil | |
| | | | | Nordel 4520 20 | |
| | | | | Nordel 4725 20 | |
| Vulcanizing | | production roll 20 h 135° C. AN139 | | | |
| | | 80 m 1.0 mm and 110 m 1.2 mm | | | |
| Rheo 3′/190° C. | ML | | | | |
| Thickness | mm | 0.91-0.95 | 1.11-1.16 | 0.98-0.99 | 1.12-1.21 |
| Density | kg/l | 1.440 | 1.440 | 1.500 | 1.500 |
| Hardness | ° Sh A | 73 | 72 | 73 | 72 |
| Tensile strength S3 | Mpa | 3.5 | 4.0 | 3.8 | 4.0 |
| Elongation at break | % | 470 | 435 | 610 | 620 |
| Tear resistance trouser | N/mm | 9.5 | 10.2 | 16.3 | 15.3 |

After aging 7 d/100° C.

| | | | | | |
|---|---|---|---|---|---|
| Hardness | ° Sh A | | | | |
| Tensile strength S3 | Mpa | 4.3 | | | |
| Elongation at break | % | 299 | | | |
| 1.0 mm Class B free | Thickness | 0.95 | 1.15 | 0.99 | 1.20 |
| hanging. | mm | | | | |
| Needed > 60 s | time s | direct | direct | 63 | 76 |
| | | extinguish | extinguish | | |
| | | both | both | 62 | 74 |

The examples set forth above are provided to give those of ordinary skill in the art a complete disclosure and description of how to make and use various embodiments of the compositions, and are not intended to limit the scope of what the inventors regard as their invention. Modifications of the above-described modes for carrying out the invention that are obvious to persons of skill in the art are intended to be within the scope of the following claims. All publications, patents and patent applications cited in this specification are incorporated herein by reference as if each such publication, patent or patent application were specifically and individually indicated to be incorporated herein by reference.

What is claimed is:

1. A composition, comprising:
ethylene propylene diene monomer (EPDM) polymer, aluminum hydroxide, expendable graphite, tris(2-ethylhexyl) phosphate, and a maleic anhydride adduct of polybutadiene, wherein the composition is mineral oil free.

2. The composition of claim 1, further comprising a curing agent.

3. The composition of claim 2, wherein the curing agent comprises sulfur or a sulfur releasing compound.

4. The composition of claim 1, further comprising an accelerator.

5. The composition of claim 4, wherein the accelerator comprises zinc oxide, steric acid, tetrabenzyl thiuram disulfide, N-cyclohexyl-2-benzothiazylesulfenamide, or a combination thereof.

6. The composition of claim 1, further comprising a filler.

7. The composition of claim 6, wherein the filler comprises carbon black.

8. The composition of claim 1, wherein the composition is halogen free.

9. The composition of claim 1, wherein the composition is antimony trioxide free.

10. A composition, comprising:
ethylene propylene diene monomer (EPDM) polymer, sulfur, tetrabenzyl thiuram disulfide, N-cyclohexyl-2-benzothiazylesulfenamide, zinc oxide, stearic acid, a maleic anhydride adduct of polybutadiene, expandable graphite, carbon black, tris(2-ethylhexyl) phosphate, and aluminum hydroxide, wherein the composition is mineral oil free.

11. A method of making an EPDM membrane comprising the steps of:
processing a homogeneous mixture of the composition of claim 1 into a membrane using either calendaring or a roller die extruder; and
heat curing the membrane.

12. The method of claim 11, further comprising the step of laminating a fabric layer to one side of the membrane before or after the membrane is vulcanized.

13. The method of claim 11, further comprising the step of laminating a fabric layer to each side of the membrane before or after the membrane is vulcanized.

14. The method of claim 11, further comprising the step of laminating a glass scrim layer to one side of the membrane before or after the membrane is vulcanized.

15. The method of claim 11, further comprising the step of laminating a glass scrim layer to each side of the membrane before or after the membrane is vulcanized.

16. A method of making an EPDM membrane comprising the steps of:
processing a homogeneous mixture of the composition of claim 10 into a membrane using either calendaring or a roller die extruder; and
heat curing the membrane.

17. The method of claim 16, further comprising the step of laminating a fabric layer to one side of the membrane before or after the membrane is vulcanized.

18. The method of claim 16, further comprising the step of laminating a fabric layer to each side of the membrane before or after the membrane is vulcanized.

19. The method of claim 16, further comprising the step of laminating a glass scrim layer to one side of the membrane before or after the membrane is vulcanized.

20. The method of claim 16, further comprising the step of laminating a glass scrim layer to each side of the membrane before or after the membrane is vulcanized.
